(19) United States
(12) Patent Application Publication
(10) Pub. No.: US 2015/0304478 A1
(43) Pub. Date: Oct. 22, 2015

(54) METHOD AND SYSTEM FOR PROVIDING INFORMATION RELATED TO MEDICAL DEVICE

(71) Applicant: SAMSUNG ELECTRONICS CO., LTD., Suwon-si (KR)

(72) Inventors: Na-hui KIM, Suwon-si (KR); Hye-won NAM, Seoul (KR)

(73) Assignee: SAMSUNG ELECTRONICS CO., LTD., Suwon-si (KR)

(21) Appl. No.: 14/688,078

(22) Filed: Apr. 16, 2015

(30) Foreign Application Priority Data
Apr. 22, 2014 (KR) 10-2014-0048202

(51) Int. Cl. H04M 1/725; H04W 12/06; H04W 4/00

(52) U.S. Cl. CPC H04M 1/7253; H04W 4/008; H04W 12/06

(57) ABSTRACT

Provided is a method for providing information which relates to at least one medical device by using a mobile terminal. The method includes: acquiring link information which relates to a server which is connected to the at least one medical device by using a short-range communication; transmitting, to the server, a request for information which relates to the at least one medical device, based on the link information; receiving, from the server, the requested information which relates to the at least one medical device; and providing the received information.

### RELATED APPLICATIONS

This application claims priority from Korean Patent Application No. 10-2014-0048202, filed on Apr. 22, 2014, in the Korean Intellectual Property Office, the disclosure of which is incorporated herein by reference in its entirety.

### BACKGROUND

1. Field

One or more exemplary embodiments relate to a method for providing information related to at least one medical device, and a mobile terminal, a medical device, and a server therefor.

2. Description of the Related Art

In diagnosing diseases efficiently and in treating illnesses, medical diagnosis equipment is a very important tool. As medical technology develops, kinds of medical devices become various and vast.

Further, because various functions may be provided by medical devices, main functions of which a user should be fully aware also increase. Currently, instructions of a medical device are provided to a user through an education program provided by a manufacturer when initially installing the medical device. However, it is difficult for the user to be well-informed of overall manipulation methods of the medical device based solely upon the education program provided when initially installing the medical device.

### SUMMARY

One or more exemplary embodiments include a method for providing information which relates to at least one medical device (for example, manipulation method information, information management information, update information) by using a mobile terminal, wherein the information is transmitted from the at least one medical device or a server connected to the at least one medical device via a short range wireless communication.

Additional aspects will be set forth in part in the description which follows and, in part, will be apparent from the description, or may be learned by practice of the presented exemplary embodiments.

According to one or more exemplary embodiments, a method for providing information which relates to at least one medical device, the method being performable by a mobile terminal, the method including: acquiring link information which relates to a server which is connected to the at least one medical device by using short-range communication; transmitting, to the server, a request for information which relates to the at least one medical device, based on the link information; receiving, from the server, the requested information which relates to the at least one medical device; and providing the received information.

The acquiring the link information may include receiving the link information from the at least one medical device via the short-range communication, and the short-range communication may be executed by using at least one from among near field communication (NFC), Bluetooth, wireless fidelity (Wi-Fi) direct (WFD), ultra wideband (UWB), Zigbee, Bluetooth low energy (BLE), and Ant+.

The transmitting the request for the information which relates to the at least one medical device may include: acquiring authentication information which indicates an access right of the mobile terminal with respect to the at least one medical device; and transmitting the acquired authentication information to the server.

The transmitting the authentication information may include transmitting, to the server, at least one from among one-time authentication information, identification information which relates to the mobile terminal, account information which relates to a user, and information which relates to the at least one medical device.

The receiving the requested information may include receiving the requested information when an authentication which relates to the authentication information has been completed.

The providing the received information may include providing at least one from among manipulation method information which relates to the at least one medical device, quality control (QC) information, and update information which relates to the at least one medical device.

The providing the received information may include providing manual information which corresponds to learning progress information which relates to a user of the mobile terminal.

The method may further include transmitting, to the server, the learning progress information which relates to the user or storing the learning progress information which relates to the user in a memory.

The method may further include: receiving, from the server, a notification message which is generated based on the learning progress information; and displaying the notification message.

The providing the received information may include: receiving an input of a search word; searching for information which corresponds to the search word; and providing the information which is obtained as a result of the searching.

According to one or more exemplary embodiments, a method for providing information which relates to at least one medical device, the method being performable by a mobile terminal, the method includes: establishing a short-range communication link with the at least one medical device; transmitting, to the at least one medical device, a request for the information which relates to the at least one medical device via the short-range communication link; receiving, from the at least one medical device, the requested information via the short-range communication link; and providing the received information.

The receiving the requested information may include: acquiring authentication information which indicates an access right of the mobile terminal with respect to the at least one medical device; transmitting the acquired authentication information to the at least one medical device; and when an authentication which relates to the authentication information has been completed, receiving the requested information from the at least one medical device.

The providing the received information may include providing manual information which corresponds to learning progress information which relates to a user.

The method may further include transmitting, to the server, the learning progress information or storing the learning progress information in a memory.

According to one or more exemplary embodiments, a method for providing information which relates to at least one medical device, the method being performable by a server, the method includes: receiving, from a mobile terminal, authentication information which indicates an access right of the mobile terminal with respect to the at least one medical device; performing an authentication which relates to the authentication information in order to determine whether the mobile terminal is permitted to access information which relates to the at least one medical device; and transmitting the information which relates to the at least one medical device to the mobile terminal, based on a result of the performing the authentication.

The transmitting the information which relates to the at least one medical device may include transmitting manual information which corresponds to learning progress information which relates to a user of the mobile terminal.

The transmitting the information which relates to the at least one medical device may include: receiving a search word from the mobile terminal; searching for information which corresponds to the search word; and transmitting, to the mobile terminal, the information which is obtained as a result of the searching.

The method may further include: generating a notification message which corresponds to learning progress information which relates to a user of the mobile terminal; and transmitting the notification message to the mobile terminal.

According to one or more exemplary embodiments, a method for providing information, the method being performable by a medical device, the method includes: establishing a short-range communication link with a mobile terminal; receiving, from the mobile terminal, authentication information which indicates an access right of the mobile terminal with respect to the medical device via the short-range communication link; performing an authentication which relates to the authentication information; and transmitting, to the mobile terminal, information which relates to the medical device via the short-range communication link, based on a result of the performing the authentication.

The transmitting the information which relates to the medical device may include transmitting manual information which corresponds to learning progress information which relates to a user of the mobile terminal.

The transmitting the information which relates to the medical device may include: receiving a search word from the mobile terminal; searching for information which corresponds to the search word; and transmitting, to the mobile terminal, the information which is obtained as a result of the searching.

According to one or more exemplary embodiments, a mobile terminal includes: a communication module configured to acquire link information which relates to a server that is connected to at least one medical device via short-range communication, to transmit, to the server, a request for information which relates to the at least one medical device, based on the link information, and to receive, from the server, the requested information which relates to the at least one medical device; and a controller configured to provide the received information.

The controller may be further configured to acquire authentication information which indicates an access right of the mobile terminal with respect to the at least one medical device, and the communication module may be further configured to transmit the authentication information to the server and to receive the requested information from the server, when an authentication which relates to the authentication information has been completed.

The controller may be further configured to provide manual information which corresponds to learning progress information which relates to a user of the mobile terminal.

The communication module may be further configured to receive, from the server, a notification message which is generated based on learning progress information which relates to a user, and the controller may be further configured to control a display device to display the notification message.

The mobile terminal may further include a user input device configured to receive an input of a search word, wherein the controller is further configured to search for information which corresponds to the search word, and to provide the information which is obtained as a result of the search.

According to one or more exemplary embodiments, a mobile terminal includes: a communication module configured to establish a short-range communication link with at least one medical device, to transmit, to the at least one medical device, a request for information which relates to the at least one medical device via the short-range communication link, and to receive, from the at least one medical device, the requested information which relates to the at least one medical device via the short-range communication link; and a controller configured to provide the received information.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a block diagram of a manual information providing system, according to an exemplary embodiment;

FIG. 2 is a flowchart of a method for providing information in which is performable by a mobile terminal, according to an exemplary embodiment;

FIG. 3 is a diagram illustrating an operation of acquiring link information which relates to a server by a mobile terminal from a medical device, according to an exemplary embodiment;

FIG. 4 is a diagram illustrating an operation of acquiring link information which relates to a server from a smart poster including a plurality of near field communication (NFC) tags by a mobile terminal, according to an exemplary embodiment;

FIG. 5 is a flowchart of a method for receiving information which relates to at least one medical device which is performable by a mobile terminal based on a verification result, according to an exemplary embodiment;

FIGS. 6A, 6B, and 6C are diagrams illustrating an operation of a mobile terminal for displaying manual information of a medical device (for example, an IVD test device), according to an exemplary embodiment;

FIG. 7 is a flowchart of a method for providing information corresponding to a search word by a mobile terminal, according to an exemplary embodiment;

FIG. 8 is a diagram showing an example of displaying a search window in a mobile terminal, according to an exemplary embodiment;

FIGS. 9A and 9B are diagrams showing examples of displaying manual information corresponding to a search word by a mobile terminal, according to an exemplary embodiment;

FIG. 10 is a diagram of an information providing system, according to another exemplary embodiment;

FIG. 11 is a flowchart of a method for providing manual information which is performable by a mobile terminal, according to another exemplary embodiment;

FIG. 12 is a diagram showing an example of providing information which relates to a medical device by using a mobile terminal, according to an exemplary embodiment;

FIG. 13 is a diagram showing an example of displaying problem solution information by using a mobile terminal, according to an exemplary embodiment;

FIG. 14 is a flowchart of a method for providing manual information corresponding learning progress information of a user which is performable by a mobile terminal, according to an exemplary embodiment;

FIGS. 15A, 15B, and 15C are diagrams illustrating operations of providing manual information corresponding to learning progress information of a user by using a mobile terminal, according to an exemplary embodiment;

FIG. 16 is a block diagram of a mobile terminal, according to an exemplary embodiment;

FIG. 17 is a block diagram of a medical device, according to an exemplary embodiment; and

FIG. 18 is a block diagram of a server, according to an exemplary embodiment.

### DETAILED DESCRIPTION

Terms used in the present disclosure have been selected as general terms which are widely used at present, in consideration of the functions of the exemplary embodiments, but may be altered according to the intent of a user of an operation unit of ordinary skill in the art, conventional practice, or introduction of new technology. Also, if there is a term which is arbitrarily selected by the applicant in a specific case, a meaning of the term will be described in detail in a corresponding description portion of the present disclosure. Therefore, the terms should be defined on the basis of the entire content of this specification instead of a simple name of each of the terms.

In this disclosure below, when it is described that one comprises (or includes or has) some elements, it should be understood that it may comprise (or include or has) only those elements, or it may comprise (or include or have) other elements as well as those elements if there is no specific limitation. Moreover, terms such as “. . . unit”, “. . . apparatus” and “module” described in the specification denote an element which is configured for performing at least one function or operation, and may be implemented in hardware, software or the combination of hardware and software.

The term “image” used herein may denote any of multi-dimensional data composed of discrete image factors (for example, pixels in a two-dimensional (2D) image and voxels in a three-dimensional (3D) image).

The term “object” used herein may include any of a person, an animal, a part of the person, or a part of the animal. For example, an object may include any of an organ such as the liver, the heart, the womb, the brain, breasts, the abdomen, or the like, or a blood vessel. Further, the term “object” may include a phantom. The phantom denotes a material having a volume very close to a density of organisms and an effective atomic number, and may include a spherical phantom having characteristics similar to those of a human body.

The term “user” used herein generally refers to a medical expert, and may include any of a doctor, a nurse, a medical technologist, a medical image expert, or the like, or may be an engineer repairing a medical apparatus. However, the user is not limited thereto.

Hereinafter, exemplary embodiments will be described in detail to be easily embodied by those of ordinary skill in the art with reference to the accompanying drawings. The present inventive concept may, however, be embodied in many different forms and should not be construed as being limited to the exemplary embodiments set forth herein. In the accompanying drawings, a portion irrelevant to a description of the present invention will be omitted for clarity. Like reference numerals refer to like elements throughout. As used herein, the term “and/or” includes any and all combinations of one or more of the associated listed items. Expressions such as “at least one of,” when preceding a list of elements, modify the entire list of elements and do not modify the individual elements of the list.

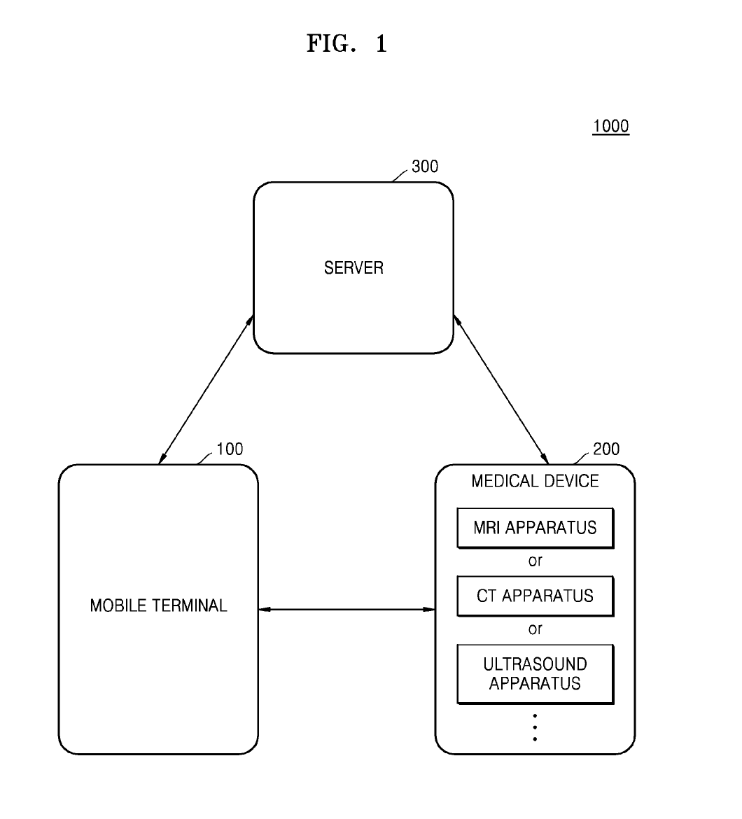

FIG. 1 is a diagram of a system 1000 for providing information which relates to a medical device, according to an exemplary embodiment.

According to the exemplary embodiment, the system 1000 for providing information which relates to a medical device may include a mobile terminal 100, at least one medical device (hereinafter, referred to as a medical device) 200, and a server 300. However, not all of the components shown in FIG. 1 are essential elements. That is, the system 1000 may include more or less elements than those of FIG. 1.

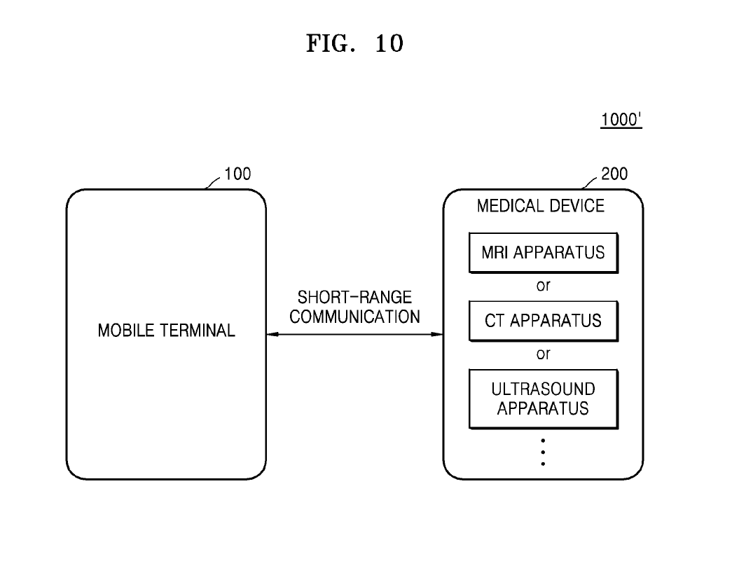

For example, according to another exemplary embodiment, the system 1000 may include the mobile terminal 100 and the medical device 200. This will be described below with reference to FIG. 10.

Hereinafter, the above components will be described in detail.

The mobile terminal 100 denotes a device that may provide information which relates to the medical device 200. For example, the mobile terminal 100 may provide manual information or update information of the medical device 200 via a certain application.

The manual information of the medical device 200 may include guidance of the medical device 200 and information about a usage method of the medical device 200. For example, the manual information may include manipulation method information of the medical device 200 (for example, any one or more of a method of capturing medical images, safety warnings and notes, problem solution information, descriptions about each portion in the system and system specification information, information about device installation, a method of correcting medical images, environment setting information, etc.) and/or quality control information (for example, an immune serum test correction method).

The update information may include information about functions that are updated within the medical device. For example, the update information may include information about an updated software version, information about added functions, information about error correction, etc.; however, the exemplary embodiments are not limited thereto. The mobile terminal 100 may communicate with the medical device 200 via a short-range communication connection. In the present specification, a short-range communication technology may include any one or more of a wireless LAN (WLAN), Wi-Fi, Bluetooth, Bluetooth low energy (BLE), ultra wideband (UWB), Zigbee, near field communication (NFC), Wi-Fi direct (WFD), infrared data association (IrDA), or the like, but is not limited thereto.

The mobile terminal 100 may receive information from the medical device 200 via the short-range communication connection. For example, the mobile terminal 100 may receive any of link information for accessing the server 300, identification information of the medical device 200, verification information, and the like from the medical device 200 via the short-range communication connection. Further, the mobile terminal 100 may receive manual information of the medical device 200 from the medical device 200 via the short-range communication connection.

The mobile terminal 100 may communicate with the server 300 via a network through wires or wirelessly. The network may be a wired network, such as, for example, any of a local area network (LAN), a wide area network (WAN), and a value added network (VAN), or a wireless network, such as, for example, any of a mobile radio communication network, a near field communication network, or a satellite communication network.

The mobile terminal 100 may access the server 300 by using at least one selected from among account information or identification information of the mobile terminal 100 (for example, a device identification (ID), a serial number, or MAC address), identification information of the medical device 200 (for example, a product name, a device ID, and MAC address). Further, the mobile terminal 100 may transmit, to the server 300, a request for manual information of the medical device 200, and may receive the manual information of the medical device 200 from the server 300 in response to the request.

The mobile terminal 100 according to the present exemplary embodiment may be realized in various types. For example, the mobile terminal 100 in the present specification may include any of a mobile phone, a smartphone, a laptop computer, a tablet PC, an electronic book terminal, a digital broadcasting terminal, a personal digital assistant (PDA), a portable multimedia player (PMP), a navigation system, a smart TV, a consumer electronic (CE) device, and the like, but is not limited thereto.

The mobile terminal 100 according to the exemplary embodiment may include a touch screen. The touch screen may be configured to detect a pressure of a touch input, as well as a touch input location and a touched area. Further, the touch screen may be configured to detect a proximity touch, as well as a real touch.

According to the exemplary embodiment, the mobile terminal 100 may sense a touch gesture of a user via the touch screen. The touch gesture (touch input) of the user may include any one or more of a tap, touch-and-hold, double tap, drag, panning, flick, drag-and-drop, swipe, and pinch, but they are not limited thereto.

The medical device 200 may be a device which is configured for acquiring medical images or diagnosing an object to be examined. For example, the medical device 200 may be a magnetic resonance imaging (MRI) apparatus, a computed tomography (CT) apparatus, an X-ray photographing apparatus (not shown), an angiography apparatus (not shown), an ultrasound apparatus, an in-vitro diagnostic medical device (IVD) (not shown, for example, a blood analyzer), and the like, but is not limited thereto.

An MRI apparatus is an apparatus which is configured for acquiring a sectional image of a part of an object by expressing, in a contrast comparison, a strength of a MR signal with respect to a radio frequency (RF) signal generated in a magnetic field having a specific strength.

Because a CT apparatus is capable of providing a cross-sectional image of an object, the CT apparatus may express an inner structure (e.g., an organ such as a kidney, a lung, etc.) of the object without an overlap therebetween, as compared to a general X-ray photographing apparatus. The CT apparatus may obtain a plurality of pieces of image data with a thickness not more than 2 mm for several tens to several hundreds of times per second and then may process the plurality of pieces of image data, so that the CT apparatus may provide a relatively accurate a cross-sectional image of the object.

An X-ray photographing apparatus is an apparatus which is configured for imaging an internal organic structure of an object by transmitting an X-ray through the object. An angiography apparatus is an apparatus which is configured for imaging blood vessels (arteries and veins), in which a contrast medium is injected through a thin tube having a diameter of about 2 mm, referred to as a catheter, by transmitting an X-ray.

An ultrasound apparatus transfers ultrasound signals from a body surface of an object toward a predetermined portion inside the object in order to obtain a tomogram image of a soft tissue or an image about blood flow by using information of the ultrasound signal reflected from organs inside the object.

An IVD may include a specimen, supplies, an analyzer, and the like for testing human derived materials such as blood or urine. The IVD may be classified based on any of immunological diagnostics, clinicochemical diagnostics, clinical microorganism diagnostics, tissue diagnostics, and molecular diagnostics.

According to an exemplary embodiment, the medical device 200 may be realized in any of various types. For example, the medical device 200 of exemplary embodiments may be realized as a moveable terminal, as well as a fixed terminal. Examples of the moveable terminal may include a smartphone, a laptop computer, a PDA, a tablet PC, and the like.

According to an exemplary embodiment, the medical device 200 may transmit/receive medical image data to/from a hospital server and/or other medical equipment in the hospital, which are connected to the medical device 200 via a picture archiving and communication system (PACS). Further, the medical device 200 may perform data communication with the server according to digital imaging and communications in medicine (DICOM).

According to an exemplary embodiment, the medical device 200 may perform a short-range communication with the mobile terminal 100. For example, the medical device 200 may include a short-range communication module (such as, for example, any of a WLAN module, Wi-Fi, Bluetooth module, BLE, UWB module, Zigbee module, NFC module, WFD module, and IrDA module).

The server 300 may manage information about the medical device 200. For example, the server 300 may store or update the manual information of the medical device 200. Further, the server 300 may transmit the information which relates to the medical device 200 to the mobile terminal 100. In particular, the server 300 may certify information usage authority of the mobile terminal 100, and may provide the authenticated mobile terminal 100 with the information which relates to the medical device 200.

The server 300 may manage manual usage information (for example, learning progress information) with respect to each user (for example, each account). For example, if the server 300 receives a request for information relating to the medical device 200 from the mobile terminal 100, the server 300 may provide the mobile terminal 100 with the manual information corresponding to the learning progress information of the user.

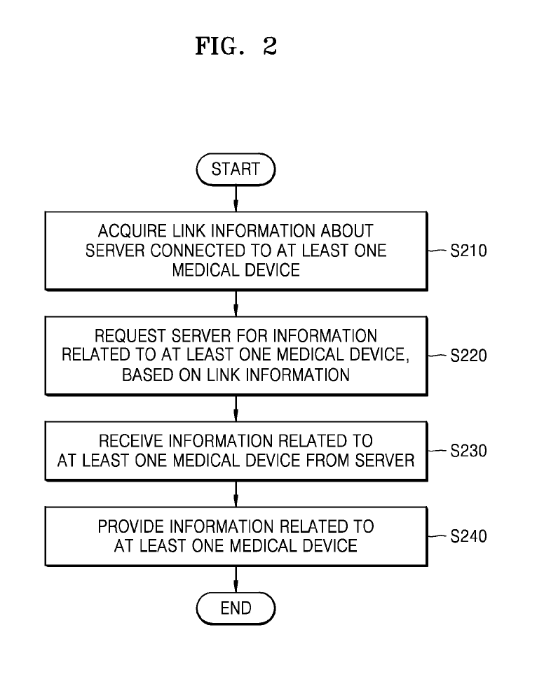

Hereinafter, a method for providing the information which relates to the medical device 200 transmitted from the server 300 to a user by the mobile terminal 100 will be described with reference to FIG. 2.

FIG. 2 is a flowchart of a method for providing information which is performable by a mobile terminal 100, according to an exemplary embodiment.

In operation S210, the mobile terminal 100 may acquire link information of the server 300 that is related to the medical device 200. The link information may include information which relates to accessing the server 300, for example, a uniform resource locator (URL), but is not limited thereto.

According to an exemplary embodiment, the mobile terminal 100 may receive link information of the server 300 from the medical device 200 via the short-range communication. The mobile terminal 100 may receive the link information of the server 300 by using at least one selected from among the NFC, Bluetooth, WFD, UWB, Zigbee, BLE, and Ant+.

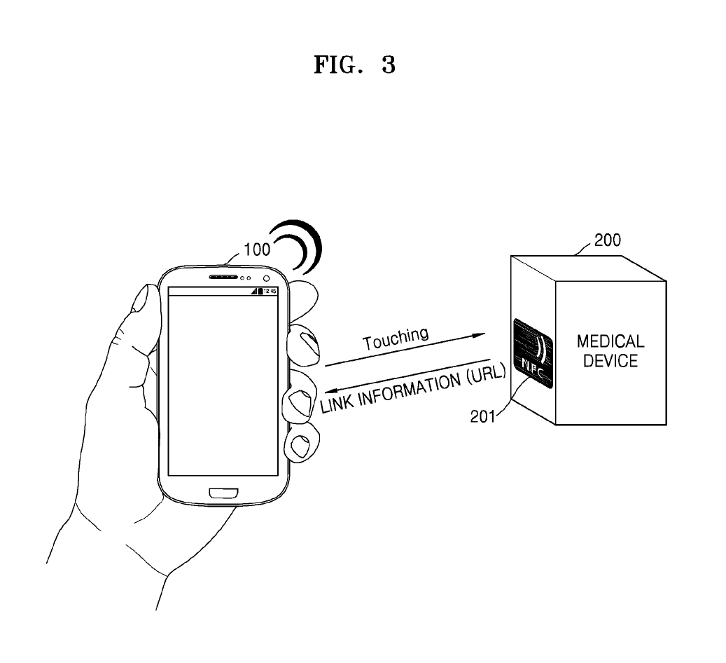

For example, if the mobile terminal 100 is located within a radius range of the NFC of the medical device 200, the mobile terminal 100 may receive the link information of the server 300 from the medical device 200 via the NFC. This will be described below with reference to FIG. 3.

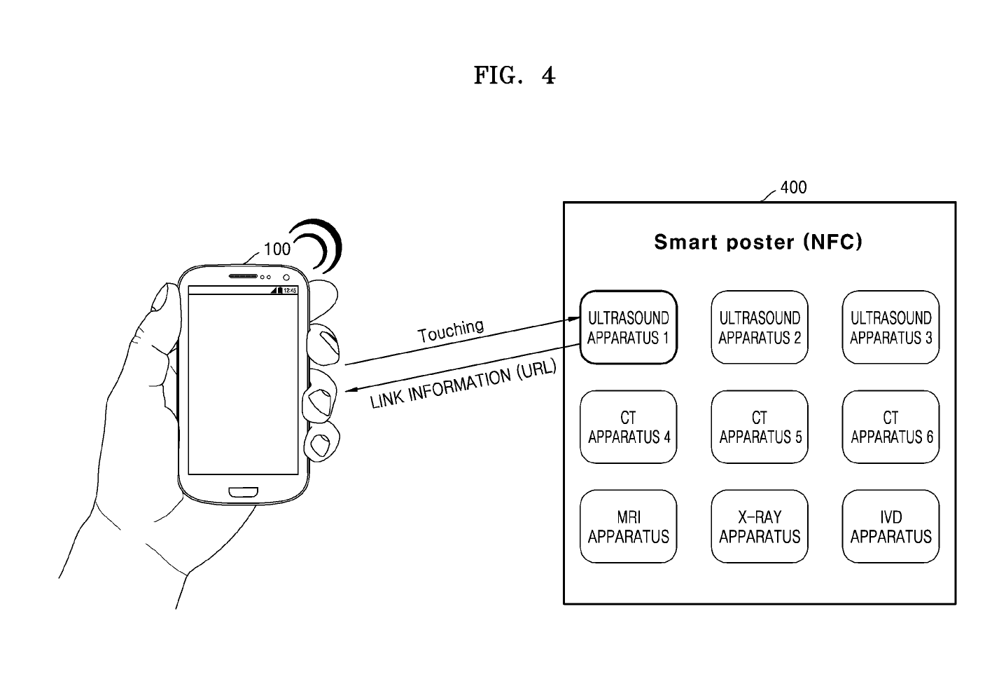

According to another exemplary embodiment, the mobile terminal 100 may receive link information of the server 300, which is related to the medical device 200, from a smart poster including at least one short-range communication tag (for example, an NFC tag, a BLE tag, a Zigbee tag). This will be described below with reference to FIG. 4.

In operation S220, the mobile terminal 100 may submit a request to the server 300 for information related to the medical device 200 based on the link information of the server 300. For example, the mobile terminal 100 may transmit information about the medical device 200 (for example, model name, device ID, or a kind of the medical device), account information, or preset code information corresponding to the manual information in order to request the server 300 for the manual information of the medical device 200.

In operation S230, the mobile terminal 100 may receive information related to the medical device 200 from the server 300. For example, the mobile terminal 100 may receive at least one selected from among manipulation method information of the medical device 200, quality control information of the medical device 200, and update information of the medical device 200 from the server 300. The manipulation method information of the medical device 200 may include any one or more of a medical image capturing method, a gain control method, a control panel manipulation method, a medical image correction method, and the like, but is not limited thereto.

The quality control information may denote information about a method of checking whether the medical device 200 normally operates, and whether medical data has errors. The update information of the medical device 200 may include any one or more of updated software version information, added function information, error correction information, and the like, but is not limited thereto.

According to an exemplary embodiment, if the medical device 200 is a blood analyzer, information related to the medical device 200 may include any one or more of information about an objective of the product (for example, this is a device for analyzing blood, which monitors reactions generated when a sample, that is, blood, is mixed with specimen in a disk by a centrifugal force by using a photometer. This device is configured to analyze enzymes, stroma, electrolytes, special proteins, immunity, etc.), safety warning and caution information (for example, caution when the system is installed, cautions before using the system, cautions when using the system, cautions when preparing a blood sample, and storage and management after using the system), problem solution information (for example, a recovery method by initiating the system when the power is not turned on or printing function does not operate), descriptions about each element in the system and system specification information, information about installation of the blood analyzer, information about a blood analyzing method (for example, turning on the analyzer, start analyzing, cancel during the analyzing, emergency stop during the analyzing, analysis finish, display result, transmit analyzing result to PC, printing analyzing result, quality control, backup analyzing result, user setting of the analyzer, screen setting (screen adjustment, brightness adjustment, screen saver settings, screen-off settings), sound settings, display format settings, automatic mode settings, printer settings, network settings, language settings, security settings, self-diagnosis, system settings, analyzer power-off, unit settings, etc.), and updated software information.

In operation S240, the mobile terminal 100 may provide the information which relates to the medical device 200.

According to an exemplary embodiment, the mobile terminal 100 may provide manual information which corresponds to the learning progress of the user. For example, if the learning process of the user is stored in a memory, the mobile terminal 100 may extract the manual information which corresponds to the learning progress information of the user and provide the extracted manual information.

Further, according to an exemplary embodiment, the mobile terminal 100 may receive manual information which corresponds to the learning progress of the user from the server 300. For example, if the user has learned step 1 through step 3 as set forth in the manual, the mobile terminal 100 may receive manual information from step 4 from the server 300 in order to provide the manual information to the user.

According to an exemplary embodiment, the mobile terminal 100 may classify information related to the medical information 200 according to categories thereof, and provide the user with the classified information. Further, the mobile terminal 100 may provide a search window so as to facilitate a search for the information related to the medical device 200.

According to an exemplary embodiment, the user may easily identify the information related to the medical device 200 by using the mobile terminal 100.

FIG. 3 is a diagram illustrating an operation of acquiring link information of the server 300 by the mobile terminal 100 from the medical device 200, according to an exemplary embodiment.

According to the present exemplary embodiment, the medical device 200 may encode the link information of the server 300 in NFC data exchange format (NDEF). In addition, the medical device 200 may store the link information of the server 300 encoded in the NDEF in a short-range wireless communication tag (NFC tag) 201.

The user may move the mobile terminal 100 toward the medical device 200 so as to approach the medical device 200 (for example, touching or tagging the NFC tag 201). Here, if the mobile terminal 100 is located within an operable communication radius of the NFC tag 201 included in the medical device 200, the mobile terminal 100 may receive the link information of the server 300 recorded in the NFC tag 201.

In addition, the medical device 200 may encrypt the link information of the server 300. Here, the medical device 200 may encrypt the link information of the server 300 by using any of various encryption algorithms. For example, the encryption algorithm such as RSA, LUC, Diffie-Hellman, Elliptic Curve, Snefru, CRC-32, CRC-16, MD2, MD4, MD5, SHA, or Haval may be used.

According to an exemplary embodiment, the mobile terminal 100 may encode authentication information for accessing the medical device 200 in the NDEF. The mobile terminal 100 may store the authentication information that is encoded in the NDEF in the NFC tag in the mobile terminal 100.

If the user moves the mobile terminal 100 so as to approach the medical device 200, the authentication information stored in the NFC tag of the mobile terminal 100 may be transmitted to the medical device 200 via the short-range wireless communication. Here, the medical device 200 may identify the mobile terminal 100 via the authentication information of the mobile terminal 100. Further, the mobile terminal 100 performs an authentication of the authentication information, and if the authentication has been completed, the mobile terminal 100 may transmit the link information of the server 300 to the mobile terminal 100.

According to an exemplary embodiment, the mobile terminal 100 and the medical device 200 may perform as an NFC reader or an NFC tag, according to necessity.

FIG. 4 is a diagram illustrating an operation of acquiring link information of the server by the mobile terminal 100 from a smart poster 400 including a plurality of NFC tags, according to an exemplary embodiment.

As shown in FIG. 4, the smart poster 400 may include a plurality of NFC tags which respectively correspond to a plurality of medical devices. For example, the smart poster 400 may include a first NFC tag 401 which corresponds to a first ultrasound device, a second NFC tag which corresponds to a second ultrasound device, a third NFC tag which corresponds to a third ultrasound device, a fourth NFC tag which corresponds to a fourth CT apparatus, a fifth NFC tag which corresponds to a fifth CT apparatus, a sixth NFC tag which corresponds to a sixth CT apparatus, a seventh NFC tag which corresponds to an MRI apparatus, an eighth NFC tag which corresponds to an X-ray apparatus, and a ninth NFC tag which corresponds to an IVD apparatus. The NFC tags included in the smart poster 400 may include link information for accessing the manual information of the corresponding medical devices, respectively.

If the user moves the mobile terminal 100 so as to approach within a short-range communication radius of the first NFC tag 401, the mobile terminal 100 may receive the link information (for example, a URL) for acquiring the manual information of the first ultrasound apparatus stored in the first NFC tag 401 from the first NFC tag 401.

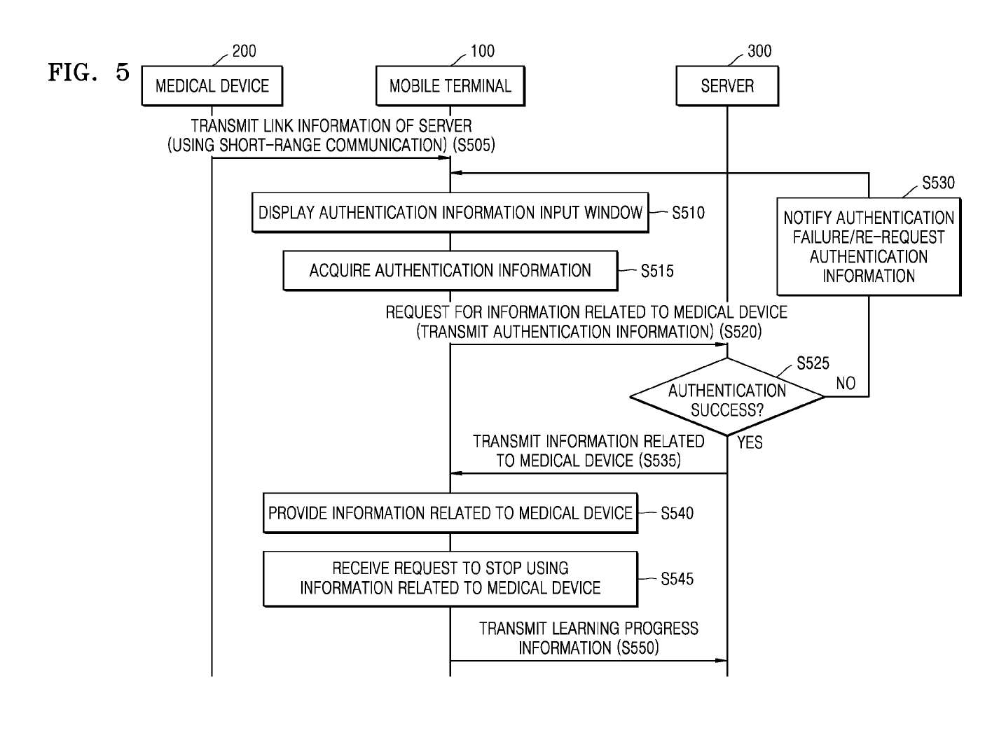

FIG. 5 is a flowchart of a method for receiving information related to at least one medical device by the mobile terminal based on an authentication result, according to an exemplary embodiment.

In operation S505, the mobile terminal 100 may receive the link information about the server 300 from the medical device 200 via the short-range communication. Since the operation S505 corresponds to operation S210 of FIG. 2, detailed descriptions thereof are omitted here.

In operation S510, when receiving the link information about the server 300, the mobile terminal 100 may display an authentication information input window for acquiring authentication information which indicates an access right of the mobile terminal with respect to the medical device 200 on a screen of the mobile terminal 100.

In operation S515, the mobile terminal 100 may acquire the authentication information via the authentication information input window. According to an exemplary embodiment, the authentication information may include at least one selected from one-time authentication information, ID information of the mobile terminal 100, account information of the user (for example, ID and password), and information about the medical device 200. Further, the authentication information may include a combination of some or all of the ID information of the mobile terminal 100, the account information of the user (for example, ID and password), and the information about the medical device 200.

According to an exemplary embodiment, when the user firstly registers the mobile terminal 100 in the server 300, the user may input an authentication code granted by a manufacturer in the authentication information input window. After registering the mobile terminal 100 in the server 300, the user may input the ID information of the mobile terminal 100 or the account information of the user as the authentication information.

In operation S520, the mobile terminal 100 may transmit a request to the server 300 for information related to the medical device 200. In this aspect, the mobile terminal 100 may transmit the authentication information to the server 300.

In operation S525, the server 300 may perform an authentication operation with respect to the authentication information in order to determine whether the mobile terminal 100 is permitted to access information related to the medical device 200.

According to the present exemplary embodiment, the mobile terminal 100 may transmit one-time authentication information granted by the manufacturer of the medical device 200 to the server 300 in initial registration. In particular, the server 300 may perform an authentication by using the one-time authentication information granted by the manufacturer. When the authentication has been completed, the server 300 may register the mobile terminal 100 in the server 300. For example, the server 300 may map the ID information of the mobile terminal 100 or the account information of the user with the ID information of the medical device 200, and may store mapped information.

After that, the mobile terminal 100 may transmit the ID information of the mobile terminal 100 and/or the account information of the user to the server 300 as the authentication information. The server 300 may perform the authentication by determining whether the ID information of the mobile terminal 100 or the account information of the user coincides with information that is stored in advance.

In operation S530, if the authentication of the authentication information has failed, the server 300 may transmit an authentication failure notification message to the mobile terminal 100 or may re-request the mobile terminal 100 for the authentication information.

In operation S535, if the authentication of the authentication information has succeeded, the server 300 may transmit information about the medical device 200 to the mobile terminal 100.

According to the present exemplary embodiment, the server 300 may transmit information which corresponds to learning progress information of the user, from among the information related to the medical device 200, to the mobile terminal 100.

Further, the server 300 may receive a search word from the mobile terminal 100, and may search for information which corresponds to the search word from among the information related to the medical device 200. In addition, the server 300 may transmit the information that is obtained as a result of the search to the mobile terminal 100.

In operation S540, the mobile terminal 100 may provide the user with the information related to the medical device 200 which has been transmitted from the server 300. Since operation S540 corresponds to operation S240 of FIG. 2, detailed descriptions thereof are omitted here.

In operation S545, the mobile terminal 100 may receive a request for stopping use of the information related to the medical device 200. For example, the mobile terminal 100 may receive a termination request of a certain application from the user while providing the manual information about the medical device 200 via the certain application.

In operation S550, if the request for stopping the use of the information related to the medical device 200 is received, the mobile terminal 100 may transmit learning progress information of the user about the information related to the medical device 200 to the server 300. For example, if the user terminates the application after learning the manual information of step 5, the mobile terminal 100 may transmit the learning progress information of the user representing that the user has learned the manual information up to step 5 to the server 300.

Alternatively, the mobile terminal 100 may store the learning progress information of the user in a local memory so as to manage the information.

According to an exemplary embodiment, the mobile terminal 100 may receive a notification message which is generated based on the learning progress information of the user from the server 300. In this case, the mobile terminal 100 may display the notification message. For example, if the user only finishes the learning of the manual up to step 5 whereas the user is required to learn the manual to step 10, the server 300 transmits a notification message notifying that learning of the manual from step 6 to step 10 has not been finished to the mobile terminal 100 in order to urge the user to continue learning.

In addition, if information related to the medical device 200 is updated, the mobile terminal 100 may receive an update notification message from the server 300 and display the update notification message.

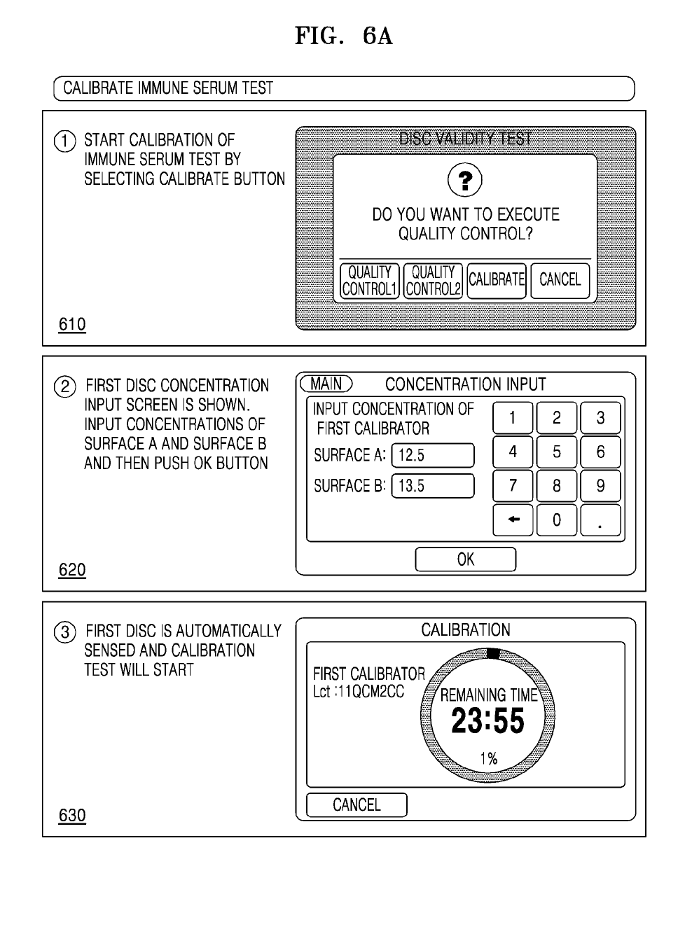

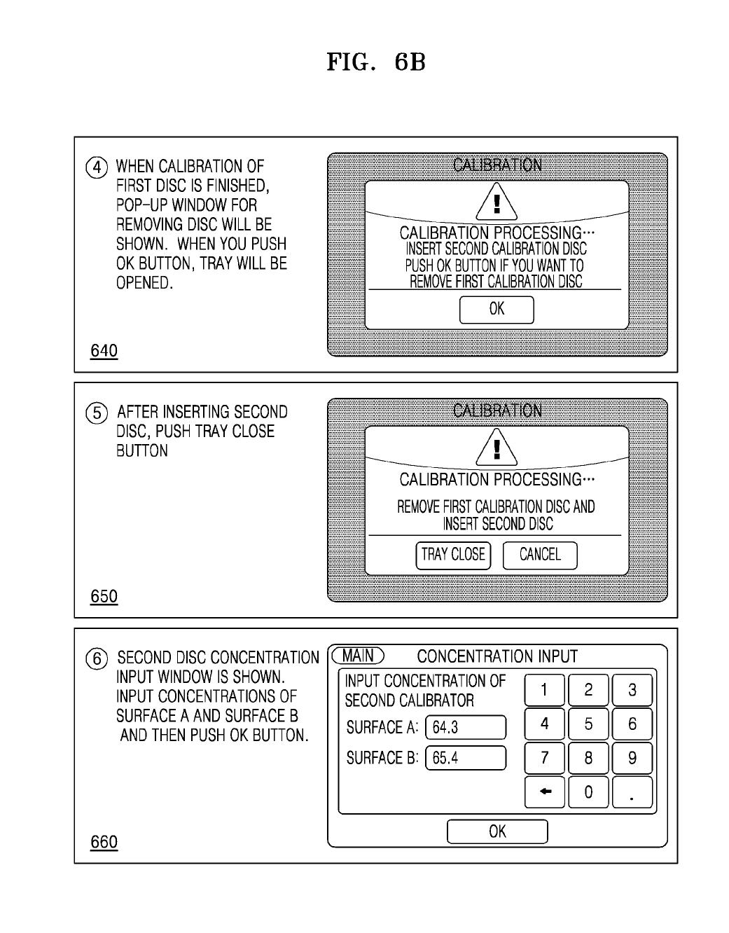

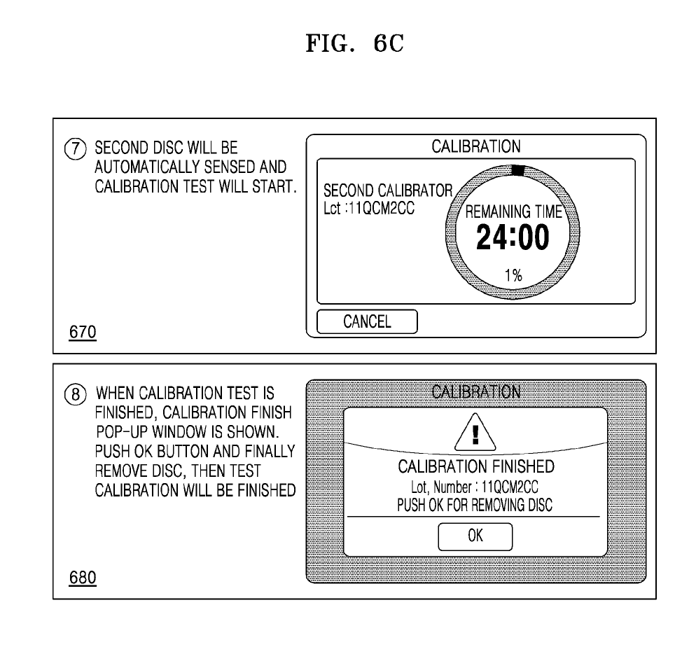

FIGS. 6A, 6B, and 6C are diagrams illustrating an operation of displaying manual information of a medical device (for example, IVD test apparatus) by the mobile terminal 100, according to an exemplary embodiment.

As shown in FIG. 6A, the mobile terminal 100 may provide first manual information 610 about a method of performing quality control (QC), second manual information 620 about a method of inputting concentration values, and third manual information 630 about a method of starting a calibration test.

As shown in FIG. 6B, the mobile terminal 100 may provide fourth manual information 640 about a method of removing a first disc, fifth manual information 650 about a method of inserting a second disc, and sixth manual information 660 about a method of inputting concentration values of the second disc.

As shown in FIG. 6C, the mobile terminal 100 may provide seventh manual information 670 about a method of starting the calibration test, and eighth manual information 680 about a method of finishing the calibration test.

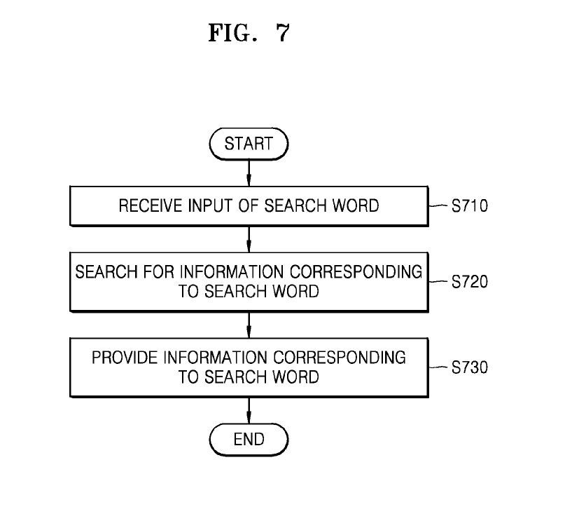

FIG. 7 is a flowchart of a method for providing information which corresponds to a search word by the mobile terminal 100, according to an exemplary embodiment.

In operation S710, the mobile terminal 100 may receive an input of a search word. For example, the user may input a certain function from among functions provided by the medical device 200 as a search word.

The mobile terminal 100 may provide a search word list including the functions provided by the medical device 200, and may receive an input of selecting one of the search word list.

In operation S720, the mobile terminal 100 may search for information which corresponds to the search word.

According to an exemplary embodiment, the mobile terminal 100 may search the information related to the medical device 200 which has been received from the server 300 for information corresponding to the search word.

Further, according to another exemplary embodiment, the mobile terminal 100 may request the server 300 for information corresponding to the search word while transmitting the search word to the server 300. In this case, the server 300 may search the information related to the medical device 200 for the information corresponding to the search word. In addition, the server 300 may transmit the information that is obtained as a result of the search to the mobile terminal 100.

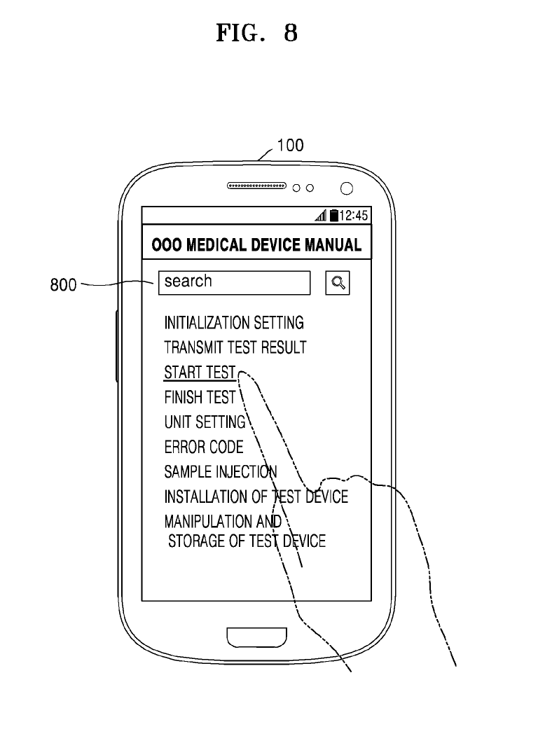

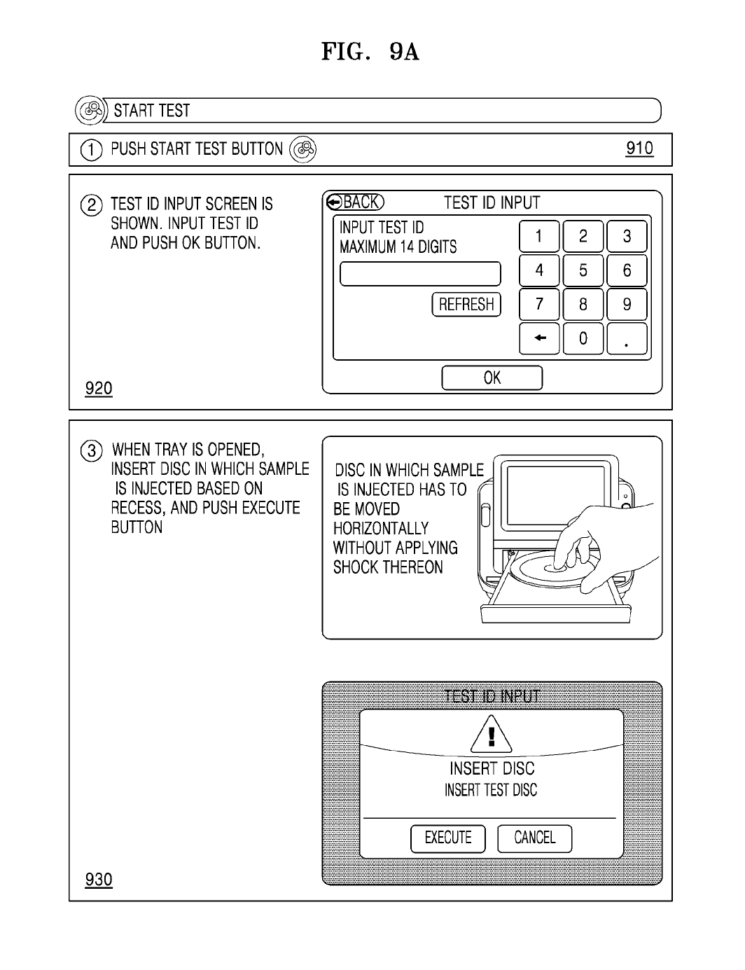

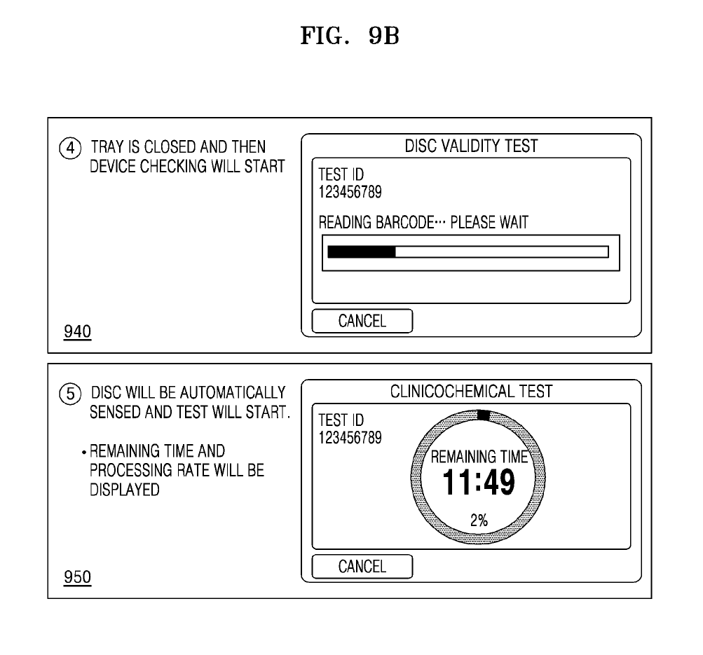

In operation S730, the mobile terminal 100 may provide the user with the obtained information. This will be described in further detail with reference to FIGS. 8 and 9.

FIG. 8 is a diagram showing an example of displaying a search window in the mobile terminal 100.

As shown in FIG. 8, the mobile terminal 100 may provide a search window 800 in which the search word may be input. The mobile terminal 100 may receive a search word, such as, for example, “initialization setting,” “test result transmission,” “start test,” “finish test,” “unit setting,” “error code,” “sample injection,” “test device installation,” and/or “manipulation and storage of the test device.” In this case, the mobile terminal 100 may provide manual information corresponding to the search word from among the manual information about a particular medical device (for example, IVD apparatus).

FIGS. 9A and 9B show an example where the user inputs a search word “start test.”

FIGS. 9A and 9B are diagrams showing an example of displaying manual information corresponding to the search word by the mobile terminal 100.

As shown in FIG. 9A, when the user inputs a search word “start test,” the mobile terminal 100 may provide manual information about a method of starting test in the medical device (for example, the IVD apparatus). For example, the mobile terminal 100 may provide first manual information 910 about an operation of pushing a start button, second manual information 920 about an operation of inputting a test ID, and third manual information 930 about an operation of inserting a disc to which a sample is injected.

As shown in FIG. 9B, the mobile terminal 100 may provide fourth manual information 940 about an operation of performing a disc validity test by the medical device (for example, the IVD apparatus), and fifth manual information 950 about an operation of sensing the disc and starting the test by the medical device (for example, the IVD apparatus).

FIG. 10 is a diagram illustrating an information providing system, according to another exemplary embodiment.

As shown in FIG. 10, an information providing system 1000′ according to another exemplary embodiment may include the mobile terminal 100 and the medical device 200.

According to the present exemplary embodiment, the mobile terminal 100 may receive information related to the medical device 200 from the medical device 200 via the short-range communication. In particular, the mobile terminal 100 may directly receive the information about the medical device 200 from the medical device 200 without using the server 300.

The mobile terminal 100 and the medical device 200 of FIG. 10 respectively correspond to the mobile terminal 100 and the medical device 200 of FIG. 1, and thus, detailed descriptions thereof are omitted.

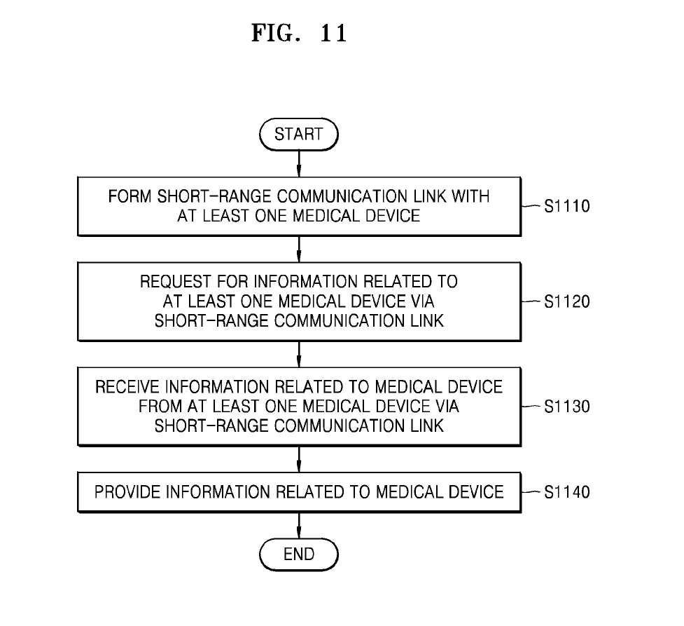

Hereinafter, a method in which the mobile terminal 100 receives and provides the information related to the medical device 200 from the medical device 200 will be described below with reference to FIG. 11.

FIG. 11 is a flowchart of a method for providing manual information by the mobile terminal 100, according to another exemplary embodiment.

In operation S1110, the mobile terminal 100 may form a short-range communication link with the medical device 200. Forming the communication link denotes a state where the mobile terminal 100 and the medical device 200 transmit/receive data to/from each other via at least one communication type.

The communication link according to the present exemplary embodiment may be a virtual communication link of a non-connection type, in which the mobile terminal 100 and the medical device 200 transmit/receive advertising packets through scanning each other, or may be a communication link of a connection type, in which a session is formed by a connection request of the mobile terminal 100. For example, the short-range communication link may include an NFC link, a BLE communication link, a sound communication link, a Bluetooth communication link, a Wi-Fi communication link, or the like, but is not limited thereto.

According to an exemplary embodiment, the mobile terminal 100 may communicate via a communication link with the medical device 200 in an out-of-band (OOB) type. For example, the mobile terminal 100 may receive communication connection information of the medical device 200 stored in the NFC tag or the BLE tag of the medical device 200 by using the NFC or the BLE.

The communication connection information of the medical device 200 according to the present exemplary embodiment denotes information that may be used by the mobile terminal 100 when requesting the medical device 200 for communication connection. For example, the communication connection information of the medical device 200 may include at least one selected from ID information of the medical device 200, capability information of the medical device 200, information about a communication type preferred by the medical device 200, status information of the medical device 200, and service identification information, but is not limited thereto.

The identification information according to an exemplary embodiment is exclusive information for identifying the medical device 200 which, for example, may include any one or more of MAC address, device ID, device name, serial number of the product, and nickname.

The capability information according to an exemplary embodiment may include any of information about functions supported by the medical device 200 (for example, BLE, Bluetooth, NFC, and Wi-Fi), information about a sensor (for example, a geomagnetic sensor, an acceleration sensor, a temperature sensor, a gyroscope sensor, and a proximity sensor), information about services that may be provided (for example, UPnP and DLNA), etc., but is not limited thereto.

The information about the preferred communication type according to an exemplary embodiment may denote information or priority between the communication types preferred by the medical device 200. For example, the medical device 200 may most strongly prefer the Bluetooth communication method, and next, the medical device 200 may secondarily prefer the Wi-Fi Direct communication method.

The state information according to an exemplary embodiment may be information which represents a current status of the medical device 200, such as, for example, any of information about activated or deactivated status of the communication unit, information about activated or deactivated status of the sensor, or information about an operation mode set in the medical device 200, but is not limited thereto.

The mobile terminal 100 may form a Bluetooth communication link or a Wi-Fi communication link with the medical device 200, based on the communication connection information received via the NFC or the BLE (for example, a service set ID (SSID), an Internet protocol (IP) information, MAC address, channel number, a security key, a Bluetooth address, product name, and profile information).

In operation S1120, the mobile terminal 100 may transmit a request to the medical device 200 for information related to the medical device 200 via the short-range communication link.

For example, the mobile terminal 100 may request the medical device 200 for the information related to the medical device 200 while transmitting the information about the mobile terminal 100 (for example, device ID and MAC address), account information of the user, and/or a preset code corresponding to the manual information.

In operation S1130, the mobile terminal 100 may receive information related to the medical device 200 via the near communication link from the medical device 200. For example, the mobile terminal 100 may receive at least one selected from among manipulation method information of the medical device 200, QC information of the medical device 200, and update information of the medical device 200 via the short-range communication link from the medical device 200.

In operation S1140, the mobile terminal 100 may provide the information related to the medical device 200 which is received from the medical device 200.

According to an exemplary embodiment, the mobile terminal 100 may provide manual information corresponding to learning progress information of the user. For example, if the learning progress information of the user is stored in a memory, the mobile terminal 100 may extract manual information corresponding to the learning progress information of the user and may provide the manual information.

According to an exemplary embodiment, the mobile terminal 100 may classify information related to the medical device 200 according to categories, and provide the classified information. Further, the mobile terminal 100 may provide a search window in order to search for the information related to the medical device 200. For example, the mobile terminal 100 may receive an input of a search word via the search window, and search for the information corresponding to the search word. In addition, the mobile terminal 100 may provide the information that is obtained as a result of the search.

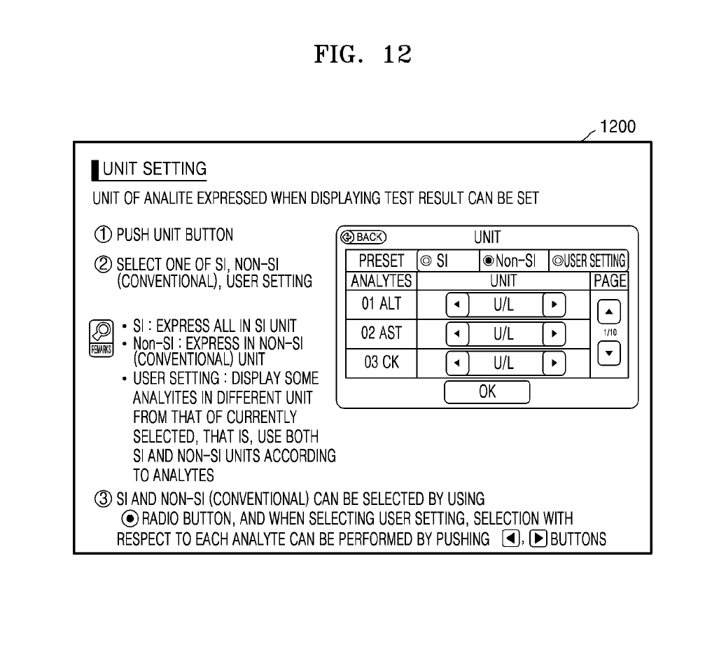

According to an exemplary embodiment, the user may easily identify the information related to the medical device 200 by using the mobile terminal 100. Referring to FIG. 12, a method for providing information by the mobile terminal 100 will be described in detail.

FIG. 12 is a diagram showing an example of providing information about the medical device 200 by the mobile terminal 100, according to an exemplary embodiment.

As shown in FIG. 12, the mobile terminal 100 may submit a request to the medical device 200 for the information related to the medical device 200 (for example, unit setting information) via the short-range communication link. In particular, the medical device 200 may transmit the information related to the medical device to the mobile terminal 100 in response to the request from the mobile terminal 100. For example, the mobile terminal 100 may receive unit setting information 1200 from the medical device 200 via the short-range communication link, and may display the unit setting information 1200 on the screen thereof.

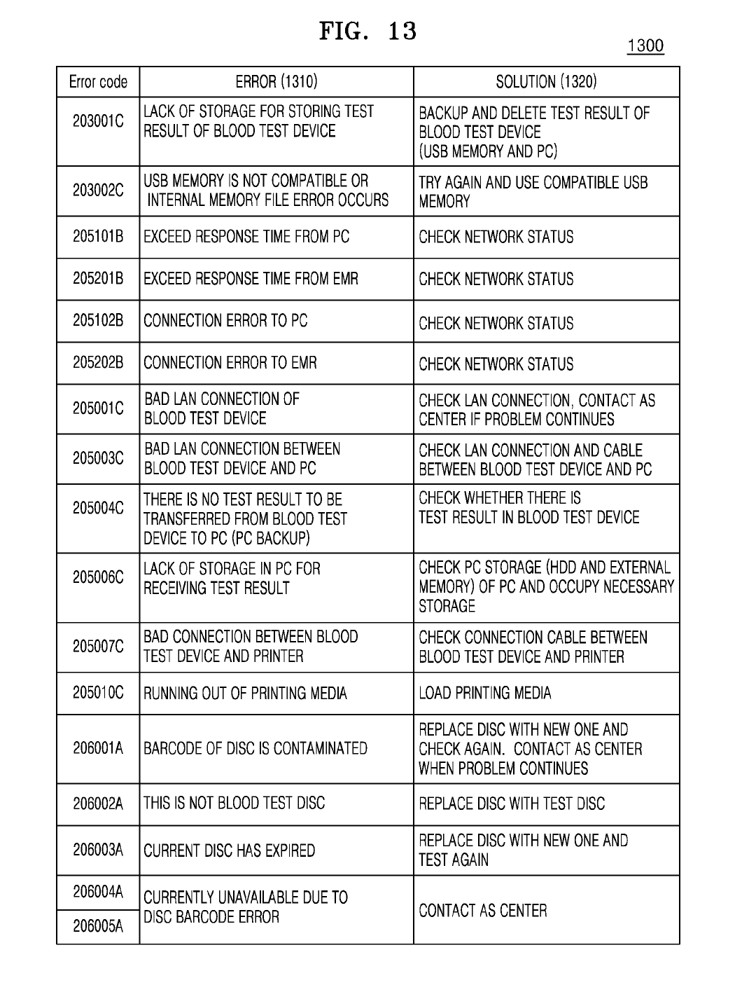

FIG. 13 is a diagram showing an example of displaying problem solution information by the mobile terminal 100, according to an exemplary embodiment.

As shown in FIG. 13, the mobile terminal 100 may submit a request to the medical device 200 for problem solution information 1300 related to the medical device 200 via the short-range communication link. In particular, the medical device 200 may provide the mobile terminal 100 with at least one of a problem 1310 currently occurring in the medical device 200 and information 1320 for solving the problem that currently occurs in the medical device 200 via the short-range communication link.

For example, if a code of an error occurring in the medical device 200 is 203001 C, the medical device 200 may provide the mobile terminal 100 with information about the error occurring in the medical device 200 (for example, lack of storage for storing blood test result) and solution (for example, back-up the blood test results (universal serial bus (USB) memory and PC) and delete). In this case, the user may address the problem occurring in the medical device 200 by using the problem solution information 1300 displayed on the mobile terminal 100.

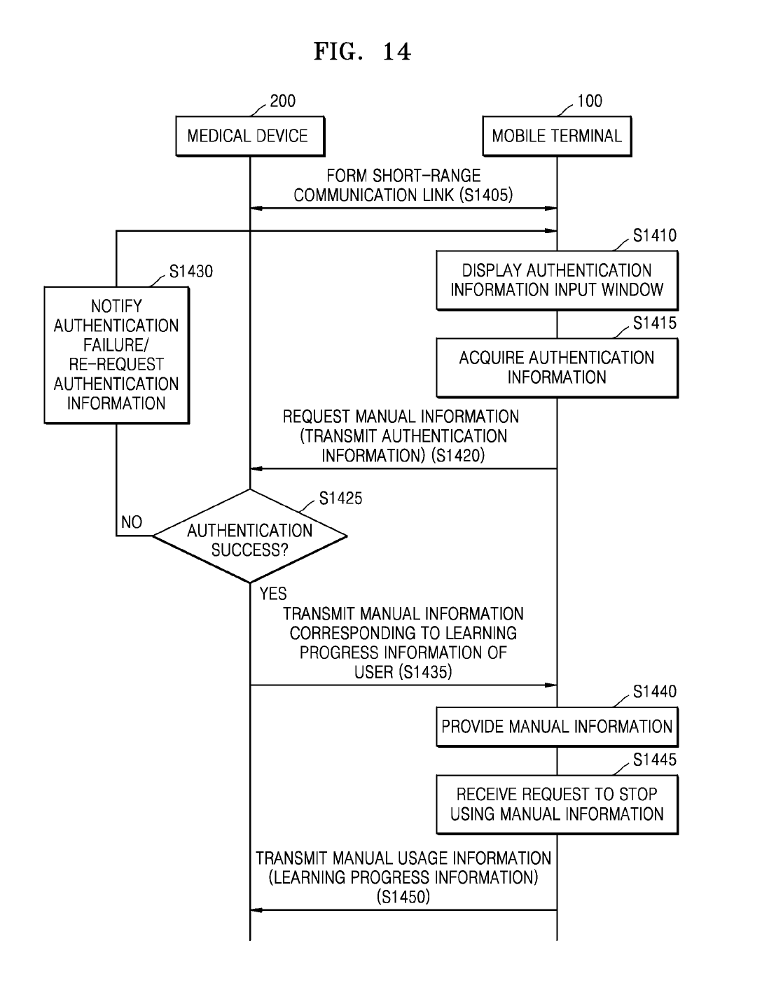

FIG. 14 is a flowchart of a method for providing manual information which corresponds to learning progress information of the user by the mobile terminal 100, according to an exemplary embodiment.

In operation S1405, the mobile terminal 100 may form a short-range communication link with the medical device 200. Because operation S1405 corresponds to operation S1110 shown in FIG. 11, detailed descriptions thereof are omitted.

In operation S1410, when the short-range communication link is formed, the mobile terminal 100 may display an authentication information input window.

In operation S1415, the mobile terminal 100 may acquire authentication information via the authentication information input window. According to the present exemplary embodiment, the authentication information includes information which indicates an access right of the mobile terminal 100 with respect to the medical device 200, and may include at least one selected from among one-time authentication information, identification information of the mobile terminal 100, account information of the user (for example, ID and password), and information about the medical device 200. Alternatively, the authentication information may include a combination of some or all of the one-time authentication information, identification information of the mobile terminal 100, account information of the user (for example, ID and password), and information about the medical device 200.

According to the present exemplary embodiment, when initially registering the mobile terminal 100 to the medical device 200, the user may input an authentication code granted by the manufacturer in the authentication information input window. After registering the mobile terminal 100 in the medical device 200, the user may input the identification information of the mobile terminal 100 and/or the account information of the user as the authentication information.

In operation S1420, the mobile terminal 100 may transmit a request to the medical device 200 for manual information via the short-range communication link. In particular, the mobile terminal 100 may transmit the authentication information to the medical device 200.

In operation S1425, the medical device 200 may perform an authentication based on the authentication information which is received from the mobile terminal 100.

According to the present exemplary embodiment, the mobile terminal 100 may transmit one-time authentication information granted by the manufacturer of the medical device 200 to the medical device 200 in the initial registration. In particular, medical device 200 may perform the authentication of the one-time authentication information. If the authentication has succeeded, the medical device 200 may execute registration processes of the mobile terminal 100. For example, the medical device 200 may store the identification information of the mobile terminal 100 and/or the account information of the user.

After that, the mobile terminal 100 may transmit the identification information of the mobile terminal 100 and/or the account information of the user to the medical device 200 as the authentication information. The medical device 200 may perform the authentication of the mobile terminal 100 by determining whether the identification information of the mobile terminal 100 or the account information of the user coincides with the information stored in advance.

In operation S1430, if the authentication of the authentication information has failed, the medical device 200 may transmit an authentication failure notification message to the mobile terminal 100 and/or may submit a renewed request to the mobile terminal 100 for the authentication information.

In operation S1435, if the authentication of the authentication information has succeeded, the medical device 200 may transmit manual information corresponding to the learning progress information of the user to the mobile terminal 100. For example, if the user has learned the manual from step 1 to step 3, the medical device 200 may transmit the manual information from step 4 to the mobile terminal 100.

Further, the medical device 200 receives a search word from the mobile terminal 100, and may search the manual information of the medical device 200 for information which corresponds to the search word. In addition, the medical device 200 may transmit the manual information that is obtained as a result of the search to the mobile terminal 100.

In operation S1440, the mobile terminal 100 may provide the user with the manual information which is received from the medical device 200. Because operation S1440 corresponds to operation S1140 of FIG. 11, detailed descriptions thereof are omitted.

In operation S1445, the mobile terminal 100 may receive a termination request with respect to the manual information. For example, the mobile terminal 100 may receive a termination request which relates to a certain application from the user while providing the manual information via the certain application.

In operation S1450, if the termination request of the manual information is received, the mobile terminal 100 may transmit manual usage information (for example, the learning progress information) to the medical device 200. For example, if the user terminates the application after learning the manual information to step 5, the mobile terminal 100 may transmit learning progress information of the user representing that the user has learned the manual information to step 5 to the medical device 200.

In addition, the mobile terminal 100 may store the manual usage information (for example, the learning progress information) in a local memory in order to manage the information.

According to the present exemplary embodiment, the mobile terminal 100 may receive a notification message which is generated based on the learning progress information of the user from the medical device 200. In this case, the mobile terminal 100 may display the notification message which is received from the medical device 200. For example, if the user has learned the manual information only to step 5 whereas the user has to learn the manual information to step 10, the medical device 200 may transmit a notification message representing that the learning of the manual information from step 6 to step 10 has not been finished to the mobile terminal 100 that is located within the short-range communication radius.

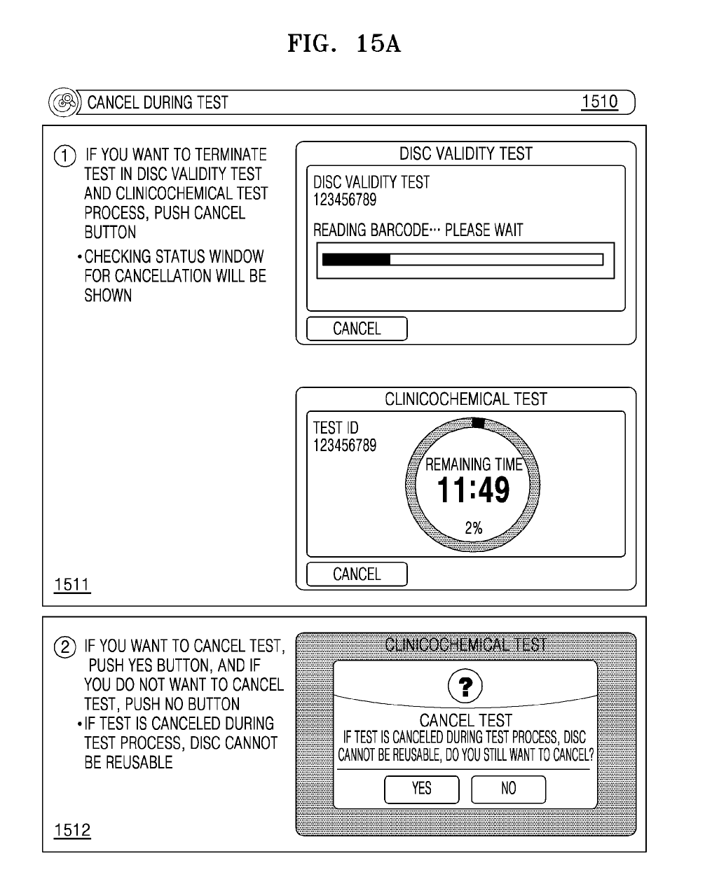

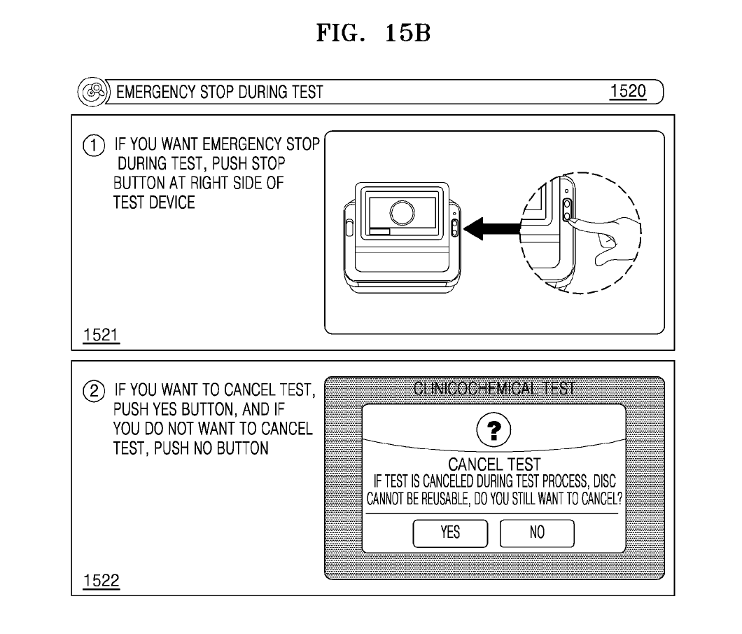

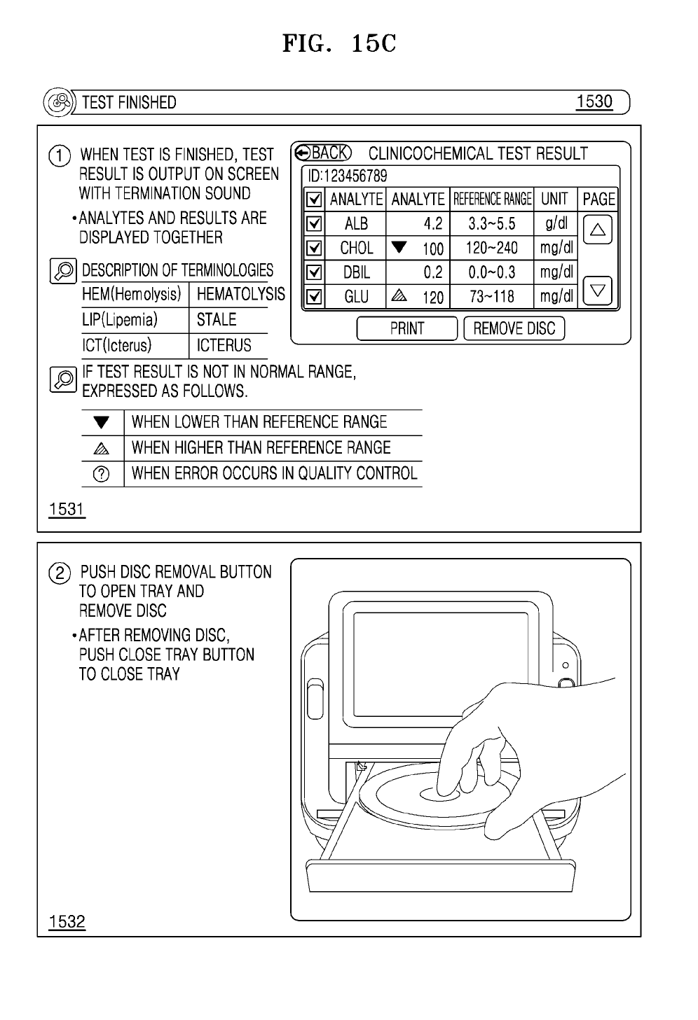

FIGS. 15A, 15B, and 15C are diagrams illustrating an operation of providing manual information which corresponds to the learning progress information of the user by the mobile terminal 100, according to an exemplary embodiment.

As shown in FIG. 15A, if the user has finished the learning of the method of starting the test, the mobile terminal 100 may provide the user with manual information about a “cancel during test” 1510 that is a next step of the method of starting the test, in consideration of the learning progress information of the user. For example, the mobile terminal 100 may provide manual information 1511 and 1522 about an operation of cancelling the test during a disc validity test and a clinicochemical test.

As shown in FIG. 15B, if the user has finished the learning of the “cancel during test” 1510, the mobile terminal 100 may provide manual information 1521 and 1522 about a method of “emergency stop during test” 1520 that is a next process of the “cancel during test” 1510.

As shown in FIG. 15C, if the user has finished the learning of the “emergency stop during test” 1520, the mobile terminal 100 may provide manual information 1531 and 1532 about a method of “test finished” 1530 that is a next process of the “emergency stop during test” 1520.

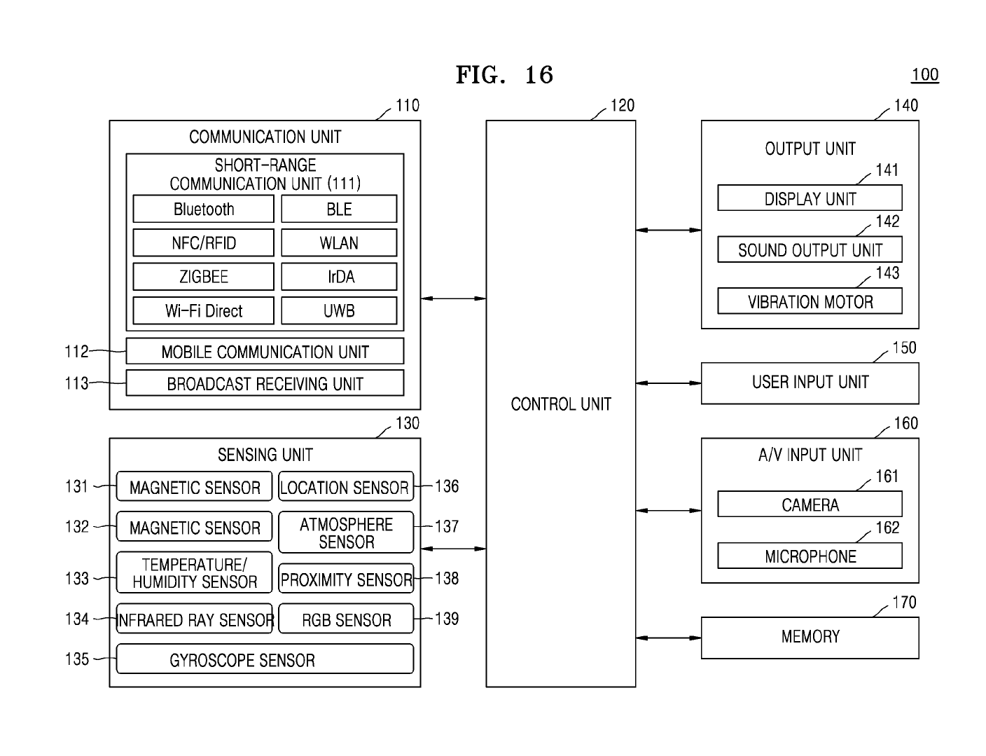

FIG. 16 is a block diagram of the mobile terminal 100, according to an exemplary embodiment.

As shown in FIG. 16, the mobile terminal 100 of the present exemplary embodiment may include a communication unit (also referred to herein as a “communication module”) 110 and a control unit (also referred to herein as a “controller”) 120. In addition, according to the present exemplary embodiment, the mobile terminal 100 may further include a sensing unit (also referred to herein as a “sensor component bank”) 130, an output unit (also referred to herein as an “output device”) 140, a user input unit (also referred to herein as a “user input device”) 150, an audio/video (A/V) input unit (also referred to herein as an “A/V input device”) 160, and a memory 170, in addition to the communication unit 110 and the control unit 120.

Hereinafter, the above components will be described below.

The communication unit 110 may include one or more components that facilitate communications between the mobile terminal 100 and the medical device 200 or the mobile terminal 100 and the server 300, thereby enabling these system elements to communicate with each other. For example, the communication unit 110 may include a short-range communication unit (also referred to herein as a “short-range communication device”) 111, a mobile communication unit (also referred to herein as a “mobile communication device”) 112, and a broadcast receiving unit (also referred to herein as a “broadcast receiver”) 113.

The short-range communication unit 111 may include any one or more of a Bluetooth communication module, a Bluetooth low energy (BLE) communication module, a short-range wireless communication module (NFC/RFID module), a WLAN communication module, a Zigbee communication module, an infrared data association (IrDA) communication module, a Wi-Fi direct (WFD) communication module, an ultra wideband (UWB) communication module, and an Ant+ communication module, but is not limited thereto.

The mobile communication unit 112 may transmit and receive a wireless signal to and from at least one selected from among a base station, an external terminal, and a server 300 in a mobile communication network. In particular, the wireless signal may include any of various types of data, according to transmission of a voice call signal, a video call signal, or text/multimedia messages.

The broadcast receiving unit 113 receives a broadcast signal and/or broadcast-related information from outside via a broadcasting channel. The broadcasting channel may include a satellite channel and/or a terrestrial channel. In some exemplary embodiments, the mobile terminal 100 may not include the broadcast receiving unit 113.

The communication unit 110 may acquire link information about the server 300 that is related to the medical device 200. The communication unit 110 may acquire the link information about the server 300 from the medical device 200 via the short-range communication. Alternatively, the communication unit 110 may acquire the link information about the server 300 from the tag included in the smart poster 400.

The communication unit 110 may transmit a request to the server 300 for manual information of the medical device 200 based on the link information. The communication unit 110 may receive the manual information of the medical device 200 from the server 300.

The communication unit 110 may transmit authentication information to the server 300, and may receive the manual information of the medical device 200 from the server 300 when the authentication of the authentication information has been completed. The communication unit 110 may receive the manual information corresponding to the learning progress information of the user from the server 300, or receive the manual information corresponding to a search which is performed based on a search word from the server 300.

The communication unit 110 may receive a notification message generated based on the learning progress information of the user from the server 300.

According to another exemplary embodiment, the communication unit 110 may form a short-range communication link with the medical device 200. The communication unit 110 may request the medical device 200 for the manual information of the medical device via the short-range communication link. The communication unit 110 may receive the manual information from the medical device 200 via the short-range communication link. The communication unit 110 may receive the manual information corresponding to the learning progress information of the user from the medical device 200, or receive the manual information corresponding to a search which is performed based on a search word from the medical device 200.

The communication unit 110 may receive a notification message which is generated based on the learning progress information of the user from the medical device 200.

The control unit 120 controls overall operations of the mobile terminal 100. For example, the control unit 120 executes programs stored in the memory 170 in order to control the communication unit 110, the sensing unit 130, the output unit 140, the user input unit 150, and the A/V input unit 160.

The control unit 120 may control the output unit 140 to provide the manual information about the medical device 200. For example, the control unit 120 may control the output unit 140 to provide the manual information corresponding to the learning progress information of the user.

The control unit 120 may acquire authentication information for authenticating usage of the medical device 200. The control unit 120 may control a display unit 141 to display a notification message transmitted from the server 300 or the medical device 200.

The control unit 120 may search for manual information which corresponds to a search word, and may provide the manual information that is found as a result of the search. In particular, the control unit 120 may directly search for the manual information corresponding to the search word, or may transmit a request to the server 300 or the medical device 200 for the manual information corresponding to the search word.

The sensing unit 130 senses a status of the mobile terminal 100 or a circumferential status of the mobile terminal 100, and transfers sensing information to the control unit 120.

The sensing unit 130 may include at least one selected from among a magnetic sensor 131, an acceleration sensor 132, a temperature/humidity sensor 133, an infrared ray sensor 134, a gyroscope sensor 135, a location sensor (for example, a global positioning system (GPS)) 136, an atmosphere sensor 137, a proximity sensor 138, and an RGB sensor (illuminance sensor) 139, but is not limited thereto. Functions of the sensors may be intuitively inferred by one of ordinary skill in the art, and thus, detailed descriptions of the sensors are omitted.

The output unit 140 may output any one or more of an audio signal, a video signal, or a vibration signal, and may include the display unit (also referred to herein as a “display device” and/or as a “display”) 141, a sound output unit (also referred to herein as a “sound output device” and/or as a “speaker”) 142, and a vibration motor 143.

The display unit 141 may display information processed by the mobile terminal 100. For example, the display unit 141 may display a user interface (UI) or a graphic user interface (GUI) related to a phone call, when the mobile phone 100 is in a phone call mode. In addition, if a searching operation of the medical device 200 has failed, the display unit 141 may display a connection (or searching) failure notification.

Further, the display unit 141 may display the manual information which is received from the server 300 or the medical device 200. The display unit 141 may display an authentication information input window for receiving an input of authentication information, and/or a search window for receiving an input of a search word.

In addition, if the display unit 141 and a touchpad are layered to form a touchscreen, the display unit 141 may be used as an input device as well as an output device. The display unit 141 may include at least one selected from among a liquid crystal display (LCD), a thin film transistor-liquid crystal display (TFT-LCD), an organic light-emitting diode (OLED), a flexible display, a 3D display, and an electrophoretic display. According to the form of the mobile terminal 100, the mobile terminal 100 may include two or more display units 141.

The sound output unit 142 may output audio data received from the communication unit 110 and/or stored in the memory 170. Further, the sound output unit 142 may output sound signals that are related to functions performed by the mobile terminal 100 (such as, for example, a call signal receiving sound and a message receiving sound). The sound output unit 142 may include any of a speaker, a buzzer, etc.

The vibration motor 143 may output a vibration signal. For example, the vibration motor 143 may output a vibration signal corresponding to an output of audio data or video data (such as, for example, a call signal receiving sound and a message receiving sound). In addition, the vibration motor 143 may output a vibration signal when a touch input is received by the touchscreen.

The user input unit 150 is a unit configured for receiving input data provided by the user to control the mobile terminal 100. For example, the user input unit 150 may include any one or more of a keypad, a dome switch, a touch pad (a capacitive overlay type, a resistive overlay type, an infrared beam type, a surface acoustic wave type, an integral strain gauge type, and a piezoelectric type), a jog wheel, or a jog switch, but is not limited thereto.

The user input unit 150 may receive an input of authentication information for authenticating the usage of the medical device 200 from the user. The user input unit 150 may receive an input of a search word.

The A/V input unit 160 is configured for receiving an input of an audio signal and/or a video signal, and may include a camera 161 and/or a microphone 162. The camera 161 may obtain an image frame such as a still image or a moving picture via an image sensor in a video call mode or a photographing mode. The image captured by the image sensor may be processed by the control unit 120 or an additional image processing unit (not shown).

The image frame processed by the camera 161 may be stored in the memory 170 and/or transmitted to outside via the communication unit 110. Two or more cameras 161 may be provided.

The microphone 162 receives a sound signal from outside and processes the sound signal as electric sound data. For example, the microphone 162 may receive a sound signal from an external device or a speaker. The microphone 162 may use any of various noise removal algorithms for removing noise generated during receiving the external sound signal.

The memory 170 may store programs for performing processes and controls of the control unit 120, and may also store input/output data (for example, manual information of the medical device 200 and learning progress information). The memory 170 may include at least one type of storage medium selected from among a flash memory type, a hard disk type, a multimedia card micro type, a card type memory (for example, SD, XD memory, etc.), random access memory (RAM), static RAM (SRAM), read only memory (ROM), electronically erasable programmable ROM (EEPROM), programmable ROM (PROM), a magnetic memory, a magnetic disk, and an optical disk. Further, the mobile terminal 100 may manage a web storage or a cloud server performing a storage function of the memory 170 on the Internet.

The programs stored in the memory 170 may be classified as any of a plurality of modules according to functions thereof, for example, a UI module, a touchscreen module, and a notification module.

The UI module may provide a specified UI or GUI in connection with the mobile terminal 100 with respect to each application. The touch screen module senses a touch gesture of the user on the touch screen, and may transmit information about the touch gesture to the control unit 120. The touch screen module according to the present exemplary embodiment may recognize and analyze a touch code. The touch screen module may be configured as additional hardware which includes a controller.

Various sensors may be provided in the touch screen or in proximity to the touch screen in order to sense the touch on the touch screen or a proximity touch. An example of the sensor for sensing the touch on the touch screen may be a tactile sensor. The tactile sensor senses a contact of a certain material at an intensity that a human being may feel or greater. The tactile sensor may sense any of various information such as roughness of a contacting surface, solidity of a contact material, and/or a temperature at a contact point.

Further, an example of the sensor for sensing the touch on the touch screen may be a proximity sensor.

The proximity sensor is a sensor which is configured for detecting whether an object approaches a previously set detection surface and/or whether the external object is present nearby by using a force of an electromagnetic field or an infrared ray without an actual physical touch. Examples of the proximity sensor include a transparent photoelectric sensor, a direct reflective photoelectric sensor, a mirror reflective photoelectric sensor, a high frequency oscillation photoelectric sensor, a capacitive photoelectric sensor, a magnetic photoelectric sensor, an infrared photoelectric sensor, etc. Touch gestures of the user may include any of a tap, a touch and hold, a double tap, a drag, panning, a flick, a drag and drop, a swipe, etc.

“Tap” refers to an operation in which the user touches the screen by using a finger or an electronic pen and then lifts the finger or the electronic pen from the screen without moving it on the screen.

“Touch & hold” is an operation in which the user touches the screen by using a finger or an electronic pen and maintains the touch input for a predetermined length of time (for example, two seconds) or longer. In particular, a time difference between a touch-in time and a touch-out time is equal to or greater than the predetermined length of time (for example, two seconds). In order for the user to recognize whether the touch input is the tap operation or the touch & hold operation, a visual, an audible, or a tactile feedback signal is transmitted when the touch input is maintained for the predetermined length of time or longer. The critical length of time may vary depending on exemplary embodiments.

“Double tap” is an operation in which the user touches the screen twice by using the finger or the electronic pen (stylus).

“Drag” is an operation in which the user touches the screen by using a finger or an electronic pen and then moves the finger or the electronic pen to another position on the screen while continuously touching the screen. An object is moved or a panning operation that will be described below is performed by the drag operation.

“Panning” is an operation in which the user performs the drag operation without selecting an object. Because the user does not select a certain object in the panning operation, a page itself moves in the screen or a group of objects moves in the page, without moving the certain object in the page.

“Flick” is an operation in which the user drags a finger or an electronic pen at a predetermined threshold speed (for example, 100 pixel/s) or faster. The drag operation (or panning operation) and the flick operation may be distinguished from each other based on whether the velocity of the finger or the electronic pen is equal to the threshold speed (for example, 100 pixel/s) or greater.

“Drag & drop” is an operation in which the user drags and drops an object at a predetermined location on the screen by using the finger or the electronic pen.

“Pinch” is an operation in which the user touches the screen by using two fingers and then moves the fingers to different directions from each other. The pinch operation is a gesture for expanding (pinch open) or reducing (pinch close) the object or the page, and an expansion value or a reduction value may be determined by a distance between the two fingers.

“Swipe” is an operation in which the user moves the finger or the electronic pen a predetermined distance in a horizontal or a vertical direction in a state of touching the object on the screen. Movement in a diagonal direction may not be considered as a swipe event.

The memory 170 may include a voice recognition module (not shown) that recognizes voice of the user by using a voice recognition engine and transmits the voice to the control unit 120.

The notification module may generate a signal for notifying an occurrence of an event in the mobile terminal 100. Examples of the event occurring in the mobile terminal 100 may include any of a reception of a call receiving signal, a reception of a notification message, an input of a key signal, and a schedule notification. The notification module may output a notification signal as a video signal format via the display unit 141, as an audio signal format via the sound output unit 142, and/or as a vibration signal format via the vibration motor 143.

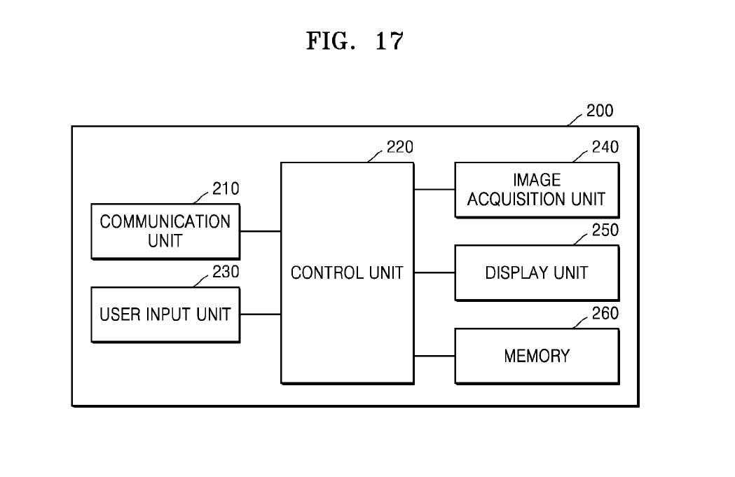

FIG. 17 is a block diagram of the medical device 200, according to an exemplary embodiment.

As shown in FIG. 17, the medical device 200 may include a communication unit 210 and a control unit 220. Further, according to the present exemplary embodiment, the medical device 200 may further include a user input unit 230, an image acquisition unit (also referred to herein as an “image acquisition device”) 240, a display unit 250, and a memory 260, in addition to the communication unit 210 and the control unit 220.

Hereinafter, the above components will be described below.

The communication unit 210 may include one or more components for facilitating communication between the medical device 200 and the server 300 and/or between the medical device 200 and the mobile terminal 100, i.e., to enable communication with each other. For example, the communication unit 210 may include any one or more of a short-range communication module, a wired communication module, a mobile communication module, etc.

The short-range communication module is a module which is configured for performing communication within a predetermined distance. The short-range communication technology may use any of Wi-Fi, Bluetooth, BLE, UWB, Zigbee, NFC, WFD, IrDA communication technology, etc.

The wired communication module is a communication module which is configured for communicating by using an electric signal or an optical signal, and the wired communication technology may include any of a pair cable, a coaxial cable, an optical fiber cable, Ethernet cable, etc.

The mobile communication module may transmit and receive a wireless signal to and from at least one selected from among a base station, an external device, and a server on a mobile communication network. In particular, the wireless signal may include any of various kinds of data according to transmission of a voice call signal, a video call signal, or text/multimedia message.

The communication unit 210 may form a short-range communication link with the mobile terminal 100. The communication unit 210 may receive authentication information for authenticating usage of the medical device 200 from the mobile terminal 100 via the short-range communication link. The communication unit 210 may transmit manual information of the medical device 200 to the mobile terminal 100 via the short-range communication link. In particular, the communication unit 210 may transmit manual information corresponding to learning progress information of the user to the mobile terminal 100.

The communication unit 210 may receive a search word from the mobile terminal 100. In particular, the communication unit 210 may transmit manual information which corresponds to the search word to the mobile terminal 100. Further, the communication unit 210 may receive learning progress information of the user from the mobile terminal 100.

The communication unit 210 is connected to a network via wires or wirelessly in order to communicate with an external device. The communication unit 210 may transmit/receive data to/from other medical devices in the hospital, which are connected to the medical device 200 via a PACS. Further, the communication unit 210 may perform data communication with the other medical devices according to DICOM.

The communication unit 210 may transmit/receive data related to diagnosis of an object (for example, medical image data of the object) via the network, and may receive medical images captured by other medical devices. Moreover, the communication unit 210 may receive information about medical history or treatment schedule of the object from a server of the hospital in order to use the information in diagnosing the object.

The control unit 220 controls overall operations of the medical device 200. For example, the control unit 220 may control the communication unit 210, the user input unit 230, the image acquisition unit 240, the display unit 250, and the memory 260.

The control unit 220 may perform an authentication based on the authentication information which is received from the mobile terminal 100. The control unit 220 may search for the manual information corresponding to a search word transmitted from the mobile terminal 100.

The user input unit 230 is a unit which is configured for receiving input data from the user in order to control the medical device 200. For example, the user input unit 230 may include may include any of a keypad, a dome switch, a touch pad (a capacitive overlay type, a resistive overlay type, an infrared beam type, a surface acoustic wave type, an integral strain gauge type, and a piezoelectric type), a jog wheel, or a jog switch, but is not limited thereto. For example, the user input unit 230 may further include any of various input units, such as an electrocardiogram (ECG) measuring module, an inspiration measuring module, a voice recognition sensor, a gesture recognition sensor, a fingerprint recognition sensor, an iris recognition sensor, a depth sensor, and/or a distance sensor.

The image acquisition unit 240 may acquire medical images of the object. For example, the image acquisition unit 240 may acquire an image by transmitting an ultrasound signal from a surface of the object toward a certain part inside the body and obtaining information of the ultrasound signal reflected by an organ in the body of the object.

Further, the image acquisition unit 240 may acquire a sectional image of a part of the object by expressing, in a contrast comparison, a strength of a MR signal with respect to an RF signal generated in a magnetic field having a specific strength. The image acquisition unit 240 may acquire a CT image and/or an X-ray image by irradiating an X-ray to the object.

The display unit 250 may display information processed by the medical device 200. For example, the display unit 250 may display medical images, and/or a UI or a GUI related to a control panel.

If the display unit 250 and a touchpad are layered to form a touchscreen, the display unit 250 may be used as an input device as well as an output device. The display unit 250 may include at least one selected from among a LCD, a TFT-LCD, an OLED, a flexible display, a 3D display, and an electrophoretic display. According to the form of the medical device 200, the medical device 200 may include two or more display units 250.

The memory 260 may store programs for controlling operations of the control unit 220, and/or may store input/output data (such as, for example, manual information, medical image data, probe information, and a body marker).

The memory 260 may include at least one type of storage medium selected from among a flash memory type, a hard disk type, a multimedia card micro type, a card type memory (for example, SD, XD memory, etc.), RAM, SRAM, ROM, EEPROM, PROM, a magnetic memory, a magnetic disk, and an optical disk. Further, the medical device 200 may manage a web storage or a cloud server performing a storage function of the memory 260 on the Internet.

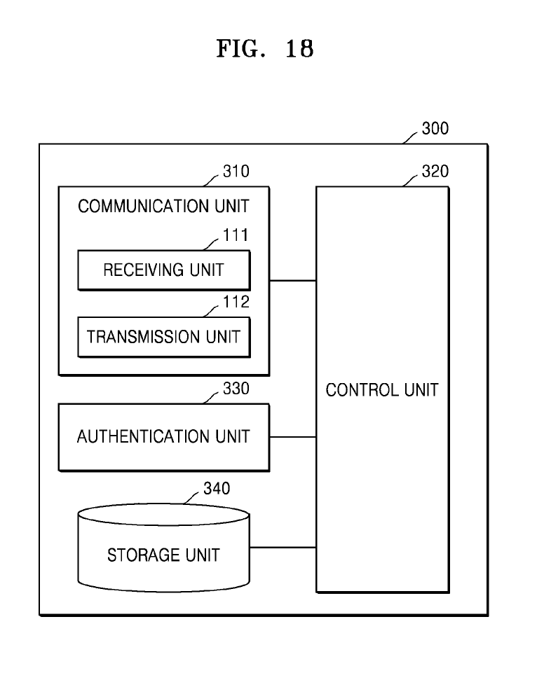

FIG. 18 is a block diagram of the server 300, according to an exemplary embodiment.

As shown in FIG. 18, the server 300 may include a communication unit 310 and a control unit 320. Further, according to the present exemplary embodiment, the server 300 may further include an authentication unit (also referred to herein as an “authentication device”) 330 and a storage unit (also referred to herein as a “storage device” and/or as a “storage”) 340, in addition to the communication unit 310 and the control unit 320.

The above components will be described below.

The communication unit 310 may include one or more components for facilitating communication between the medical device 200 and the server 300 and/or between the mobile device 100 and the server 300. For example, the communication unit 310 may include a receiving unit (also referred to herein as a “receiver”) 111 and a transmission unit (also referred to herein as a “transmitter”) 112.

The communication unit 310 may receive a signal for requesting the manual information of the medical device 200 from the mobile terminal 100. The communication unit 310 may receive authentication information for authenticating usage of the medical device 200 from the mobile terminal 100.

The communication unit 310 may transmit the manual information of the medical device 200 to the mobile terminal 100, based on the authentication result. For example, the communication unit 310 may transmit the manual information corresponding to the learning progress information of the user to the mobile terminal 100.

The communication unit 310 may receive a search word from the mobile terminal 100. In addition, the communication unit 310 may transmit the manual information which corresponds to the search word to the mobile terminal 100.

The control unit 320 may control overall operations of the server 300. For example, the control unit 320 may control the communication unit 310, the authentication unit 330, and the storage unit 340.

The control unit 320 may extract manual information which corresponds to the learning progress information of the user. In addition, the control unit 320 may search for the manual information which corresponds to the search word received from the mobile terminal 100.

The authentication unit 330 may perform an authentication with respect to the authentication information transmitted from the mobile terminal 100. For example, the authentication unit 330 may compare the authentication information transmitted from the mobile terminal 100 with authentication information stored therein in advance. The authentication information may include at least one selected from among one-time authentication information, identification information of the mobile terminal 100, account information of the user, and information about the medical device 200.

The storage unit 340 may store programs for processing and controlling of the control unit 320, and/or input/output data. For example, the storage unit 340 may store identification information of the medical device 200, manual information of the medical device 200, learning progress information of the user, and identification information of the mobile terminal 100.

The above-described exemplary embodiments may be implemented with at least one processor and include a transitory or non-transitory computer readable medium which includes program instructions for executing various operations realized by a computer. The computer readable medium may include program instructions, a data file, and a data structure, separately or cooperatively. The program instructions and the media may be specially designed and constructed for the purposes of one or more exemplary embodiments, or they may be of a kind well known and available to one of ordinary skill in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also include transmission media such as optical or metallic lines, wave guides, etc. specifying the program instructions, data structures, etc. Examples of the program instructions include both machine code, such as that produced by a compiler, and files containing high-level languages codes that may be executed by the computer using an interpreter.

According to the exemplary embodiments, the mobile terminal 100 may enable the user to easily identify the manual information which relates to the medical device 200.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present inventive concept as defined by the following claims.

What is claimed is:

1. A method for providing information which relates to at least one medical device, the method being performable by a mobile terminal, the method comprising:
acquiring link information which relates to a server which is connected to the at least one medical device by using short-range communication;
transmitting, to the server, a request for information which relates to the at least one medical device, based on the link information;
receiving, from the server, the requested information which relates to the at least one medical device; and
providing the received information.

2. The method of claim 1, wherein the acquiring the link information comprises receiving the link information from the at least one medical device via the short-range communication, and the short-range communication is executed by using at least one from among near field communication (NFC), Bluetooth, wireless fidelity (Wi-Fi) direct (WFD), ultra wideband (UWB), Zigbee, Bluetooth low energy (BLE), and Ant+.

3. The method of claim 1, wherein the transmitting the request for the information which relates to the at least one medical device comprises:
acquiring authentication information which indicates an access right of the mobile terminal with respect to the at least one medical device; and
transmitting the acquired authentication information to the server.

4. The method of claim 3, wherein the transmitting the authentication information comprises transmitting, to the server, at least one from among one-time authentication information, identification information which relates to the mobile terminal, account information which relates to a user, and information which relates to the at least one medical device.

5. The method of claim 3, wherein the receiving the requested information comprises receiving the requested information when an authentication which relates to the authentication information has been completed.

6. The method of claim 1, wherein the providing the received information comprises providing at least one from among manipulation method information which relates to the at least one medical device, quality control (QC) information, and update information which relates to the at least one medical device.

7. The method of claim 1, wherein the providing the received information comprises providing manual information which corresponds to learning progress information which relates to a user of the mobile terminal.

8. The method of claim 7, further comprising at least one from among transmitting, to the server, the learning progress information and storing the learning progress information in a memory.

9. The method of claim 8, further comprising:
receiving, from the server, a notification message which is generated based on the learning progress information; and
displaying the notification message.

10. The method of claim 1, wherein the providing the received information comprises:
receiving an input of a search word;
searching for information which corresponds to the search word; and
providing the information which is obtained as a result of the searching.

11. A method for providing information which relates to at least one medical device, the method being performable by a mobile terminal, the method comprising:
establishing a short-range communication link with the at least one medical device;
transmitting, to the at least one medical device, a request for the information which relates to the at least one medical device via the established short-range communication link;
receiving, from the at least one medical device, the requested information via the short-range communication link; and
providing the received information.

12. The method of claim 11, wherein the receiving the requested information comprises:
acquiring authentication information which indicates an access right of the mobile terminal with respect to the at least one medical device;
transmitting the acquired authentication information to the at least one medical device; and
when an authentication which relates to the authentication information has been completed, receiving the requested information from the at least one medical device.

13. The method of claim 11, wherein the information which relates to the at least one medical device comprises at least one from among manipulation method information which relates to the at least one medical device, quality control (QC) information, and update information which relates to the at least one medical device.

14. The method of claim 11, wherein the providing the received information comprises providing manual information which corresponds to learning progress information which relates to a user.

15. The method of claim 14, further comprising at least one from among transmitting, to the server, the learning progress information and storing the learning progress information in a memory.

16. The method of claim 11, wherein the providing the received information comprises:
receiving an input of a search word;
searching for information which corresponds to the search word; and
providing the information which is obtained as a result of the searching.

17. A method for providing information which relates to at least one medical device, the method being performable by a server, the method comprising:
receiving, from a mobile terminal, authentication information which indicates an access right of the mobile terminal with respect to the at least one medical device;
performing an authentication which relates to the authentication information in order to determine whether the mobile terminal is permitted to access information which relates to the at least one medical device; and
transmitting the information which relates to the at least one medical device to the mobile terminal, based on a result of the performing the authentication.

18. The method of claim 17, wherein the authentication information comprises at least one from among one-time authentication information, identification information which relates to the mobile terminal, account information which relates to a user, and information which relates to the at least one medical device.

19. The method of claim 17, wherein the transmitting the information which relates to the at least one medical device comprises transmitting manual information which corresponds to learning progress information which relates to a user of the mobile terminal.

20. The method of claim 17, wherein the transmitting the information which relates to the at least one medical device comprises:
receiving a search word from the mobile terminal;
searching for information which corresponds to the search word; and
transmitting, to the mobile terminal, the information which is obtained as a result of the searching.

21. The method of claim 17, further comprising:
generating a notification message which corresponds to learning progress information which relates to a user of the mobile terminal; and
transmitting the notification message to the mobile terminal.

22. A method for providing information, the method being performable by a medical device, the method comprising:
establishing a short-range communication link with a mobile terminal;
receiving, from the mobile terminal, authentication information which indicates an access right of the mobile terminal with respect to the medical device via the short-range communication link;
performing an authentication which relates to the authentication information; and
transmitting, to the mobile terminal, information which relates to the medical device via the short-range communication link, based on a result of the performing the authentication.

23. The method of claim 22, wherein the transmitting the information which relates to the medical device comprises transmitting manual information which corresponds to learning progress information which relates to a user of the mobile terminal.

24. The method of claim 22, wherein the transmitting the information which relates to the medical device comprises:
receiving a search word from the mobile terminal;
searching for information which corresponds to the search word; and
transmitting, to the mobile terminal, the information which is obtained as a result of the searching.

25. A mobile terminal comprising:
a communication module configured to acquire link information which relates to a server that is connected to at least one medical device via short-range communication, to transmit, to the server, a request for information which relates to the at least one medical device, based on the link information, and to receive, from the server, the requested information which relates to the at least one medical device; and
a controller configured to provide the received information.

26. The mobile terminal of claim 25, wherein the controller is further configured to acquire authentication information which indicates an access right of the mobile terminal with respect to the at least one medical device, and the communication module is further configured to transmit the authentication information to the server and to receive the requested information from the server, when an authentication which relates to the authentication information has been completed.

27. The mobile terminal of claim 25, wherein the controller is further configured to provide manual information which corresponds to learning progress information which relates to a user of the mobile terminal.

28. The mobile terminal of claim 25, wherein the communication module is further configured to receive, from the server, a notification message which is generated based on learning progress information which relates to a user, and the controller is further configured to control a display device to display the notification message.

29. The mobile terminal of claim 25, further comprising a user input device configured to receive an input of a search word,
wherein the controller is further configured to search for information which corresponds to the search word, and to provide the information which is obtained as a result of the search.

30. A mobile terminal comprising:
a communication module configured to establish a short-range communication link with at least one medical device, to transmit, to the at least one medical device, a request for information which relates to the at least one medical device via the short-range communication link, and to receive, from the at least one medical device, the requested information which relates to the at least one medical device via the short-range communication link; and
a controller configured to provide the received information.

31. A non-transitory computer-readable recording medium having embodied thereon a program, which when executed by a computer, performs the method of claim 1.
